(19) United States
(12) Patent Application Publication
(10) Pub. No.: US 2024/0334529 A1
(43) Pub. Date: Oct. 3, 2024

(54) METHOD AND APPARATUS FOR NW INDICATION-BASED PACKET DISCARD IN WIRELESS COMMUNICATION SYSTEMS

(71) Applicant: Samsung Electronics Co., Ltd., Suwon-si (KR)

(72) Inventors: Taeseop LEE, Suwon-si (KR); Sangkyu BAEK, Suwon-si (KR); Hyunjeong KANG, Suwon-si (KR)

(21) Appl. No.: 18/620,790

(22) Filed: Mar. 28, 2024

(30) Foreign Application Priority Data
Mar. 30, 2023 (KR) 10-2023-0042207
Aug. 16, 2023 (KR) 10-2023-0107086
Oct. 13, 2023 (KR) 10-2023-0136922

(51) Int. Cl. H04W 76/20; H04W 8/22; H04W 28/06; H04W 80/02

(52) U.S. Cl. CPC H04W 76/20; H04W 8/22; H04W 28/06; H04W 80/02

(57) ABSTRACT

The disclosure relates to a 5th generation (5G) communication system or a 6th generation (6G) communication system for supporting higher data rates. More particularly, the disclosure relates to a method performed by a terminal in a communication system comprising receiving, from a base station, a radio resource control (RRC) message including a first value of a first timer and a second value of a second timer for low importance; receiving, from the base station, a medium access control (MAC) control element (CE) for activating a protocol data unit (PDU) set importance (PSI) based discard; starting the second timer based on reception of a packet data convergence protocol (PDCP) service data unit (SDU) belonging to a low importance PDU set; and discarding the PDCP SDU belonging to the low importance PDU set based on an expiration of the second timer.

### CROSS REFERENCE TO RELATED APPLICATIONS

The present application claims priority under 35 U.S.C. § 119 to Korean Patent Application Nos. 10-2023-0042207, filed Mar. 30, 2023, 10-2023-0107086, filed Aug. 16, 2023, and 10-2023-0136922, filed Oct. 13, 2023, the entire contents of which is incorporated herein for all purposes by this reference.

### BACKGROUND

### 1. Field

The disclosure relates to an operation of a terminal and a base station in a wireless communication system, and specifically relates to a method and apparatus for a terminal to discard an uplink transmission packet according to a network indication.

### 2. Description of the Related Art

Fifth generation (5G) mobile communication technologies define broad frequency bands such that high transmission rates and new services are possible, and may be implemented not only in “Sub 6 gigahertz (GHz)” bands such as 3.5 GHz, but also in “Above 6 GHz” bands referred to as millimeter wave (mmWave) such as 28 GHz and 39 GHz. In addition, it has been considered to implement sixth generation (6G) mobile communication technologies, which is referred to as Beyond 5G systems, in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting numerologies (operating multiple subcarrier spacings, etc.) for efficiently utilizing mmWave resources and dynamic operation of slot formats, initial access technologies for supporting multi-beam transmission and broadbands, definition and operation of Band-Width Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIOT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, Mobile Edge Computing (MEC) for receiving services based on UE positions, and the like.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, drone communication, and the like.

Furthermore, such development of 5G mobile communication systems will serve as a basis for developing not only new waveforms for ensuring coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS) technology, but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosed embodiment is to provide an apparatus and method that may effectively provide XR services in a wireless communication system.

In various embodiments, a method performed by a terminal in a communication system comprising receiving, from a base station, a radio resource control (RRC) message including a first value of a first timer and a second value of a second timer for low importance; receiving, from the base station, a medium access control (MAC) control element (CE) for activating a protocol data unit (PDU) set importance (PSI) based discard; starting the second timer based on reception of a packet data convergence protocol (PDCP) service data unit (SDU) belonging to a low importance PDU set; and discarding the PDCP SDU belonging to the low importance PDU set based on an expiration of the second timer.

In various embodiments, a method performed by a base station in a communication system comprising transmitting, to a terminal, a radio resource control (RRC) message including a first value of a first timer and a second value of a second timer; and transmitting, to the terminal, a medium access control (MAC) control element (CE) for activating a protocol data unit (PDU) set importance (PSI) based discard, wherein the second timer is associated with a packet data convergence protocol (PDCP) service data unit (SDU) belonging to a low importance PDU set, and wherein the PDCP SDU belonging to the low importance PDU set is discarded based on an expiration of the second timer.

In various embodiments, a terminal in a communication system comprising a transceiver; and a controller configured to receive from a base station, via the transceiver, a radio resource control (RRC) message including a first value of a first timer and a second value of a second timer for low importance, and receive from the base station, via the transceiver, a medium access control (MAC) control element (CE) for activating a protocol data unit (PDU) set importance (PSI) based discard, start the second timer based on reception of a packet data convergence protocol (PDCP) service data unit (SDU) belonging to a low importance PDU set, and discard the PDCP SDU belonging to the low importance PDU set based on an expiration of the second timer.

In various embodiments, a base station in a communication system comprising a transceiver; and a controller configured to transmit to a terminal, via the transceiver, a radio resource control (RRC) message including a first value of a first timer and a second value of a second timer, and transmit to the terminal, via the transceiver, a medium access control (MAC) control element (CE) for activating a protocol data unit (PDU) set importance (PSI) based discard, wherein the second timer is associated with a packet data convergence protocol (PDCP) service data unit (SDU) belonging to a low importance PDU set, and wherein the PDCP SDU belonging to the low importance PDU set is discarded based on an expiration of the second timer. The disclosed provides an apparatus and method that may effectively provide XR services in a wireless communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a diagram of a structure of a next generation mobile communication system according to an embodiment of the disclosure.

FIG. 2 illustrates a radio protocol architecture of a long term evolution (LTE) and new radio (NR) system according to an embodiment of the disclosure.

FIG. 3 illustrates a construction of a protocol data unit (PDU) set in an application data unit (ADU) according to an embodiment of the disclosure.

FIG. 4 illustrates an operation and procedure in which a terminal discards an uplink transmission packet based on PDU set importance according to a network indication according to an embodiment of the disclosure.

FIG. 5 illustrates various operation methods and procedures in which a terminal discards an uplink transmission packet based on PDU set importance according to a network indication according to an embodiment of the disclosure.

FIG. 6 illustrates an operation and procedure in which a terminal discards a PDCP SDU based on PDU set importance for a specific time according to a network indication according to an embodiment of the disclosure.

FIG. 7 illustrates an operation and procedure in which a terminal uses a separate discarding timer value in units of PDU set importance according to a network indication according to an embodiment of the disclosure.

FIG. 8 illustrates an operation and procedure for changing a PDCP discarding timer value used in a PDCP layer for each DRB unit of a terminal according to a network indication according to an embodiment of the disclosure.

FIG. 9 illustrates a procedure in which a terminal reports information about an uplink packet waiting to be transmitted to a base station to assist in indicating a PDCP discarding operation based on PDU set importance of a network according to an embodiment of the disclosure.

FIG. 10 illustrates a PDU set discarding operation method in a PDCP layer according to an embodiment of the disclosure.

FIG. 11 illustrates a terminal apparatus according to an embodiment of the disclosure.

FIG. 12 illustrates a base station apparatus according to an embodiment of the disclosure.

### DETAILED DESCRIPTION

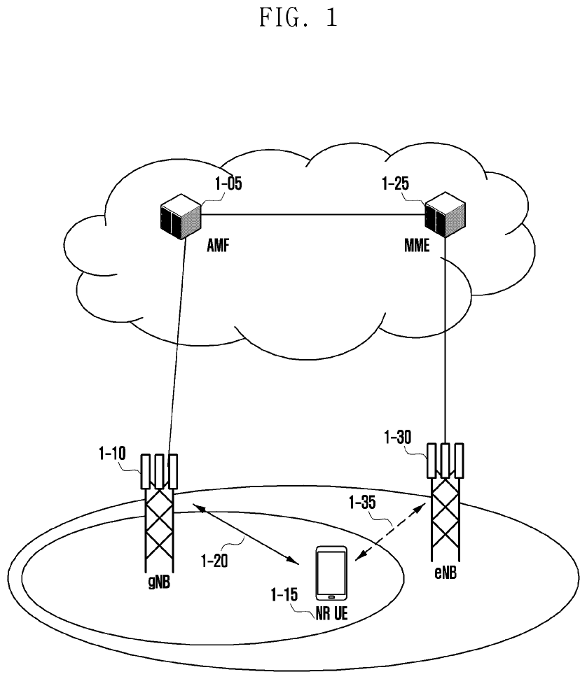

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described with reference to accompanying drawings. In addition, while describing the disclosure, detailed description of related well-known functions or constructions may be omitted when it is deemed that they may unnecessarily obscure the essence of the disclosure. Also, terms used below are defined in consideration of functions in the disclosure, and may have different meanings according to an intention of a user or operator, customs, or the like. Thus, the terms should be defined based on the description throughout the specification. Hereinafter, embodiments of the disclosure will be described with reference to accompanying drawings.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The embodiments are provided only to completely disclose the disclosure and inform those skilled in the art of the scope of the disclosure, and the disclosure is defined only by the scope of the appended claims. Throughout the specification, the same or like reference numerals designate the same or like elements.

Here, it will be understood that combinations of blocks in flowcharts or process flow diagrams may be performed by computer program instructions. Because these computer program instructions may be loaded into a processor of a general purpose computer, a special purpose computer, or another programmable data processing apparatus, the instructions, which are performed by a processor of a computer or another programmable data processing apparatus, create means for performing functions described in the flowchart block(s). The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufacturing items containing instruction means for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It should also be noted that in some alternative implementations, functions mentioned in blocks may occur out of order. For example, two blocks illustrated successively may actually be executed substantially concurrently, or the blocks may sometimes be performed in a reverse order according to the corresponding function.

Here, the term “unit” used in the disclosure means a software component or hardware component such as field programmable gate array (FPGA) or application specific integrated circuit (ASIC), and performs a specific function. However, the term “unit” is not limited to software or hardware. The “unit” may be formed so as to be in an addressable storage medium, or may be formed so as to operate one or more processors. Thus, for example, the term “unit” may refer to components such as software components, object-oriented software components, class components, and task components, and may include processes, functions, attributes, procedures, subroutines, segments of program code, drivers, firmware, micro codes, circuits, data, a database, data structures, tables, arrays, or variables. A function provided by the components and “units” may be associated with the smaller number of components and “units”, or may be further divided into additional components and “units”. Furthermore, the components and “units” may be embodied to reproduce one or more CPUs in a device or security multimedia card. In addition, in an embodiment “units” may include one or more processors.

In describing the disclosure below, detailed description of related well-known functions or constructions may be omitted when it is deemed that they may unnecessarily obscure the essence of the disclosure. Hereinafter, embodiments of the disclosure will be described with reference to accompanying drawings.

In the following description, terms identifying access nodes, terms indicating network entities, terms indicating messages, terms indicating interfaces between network entities, terms indicating various types of identification information, etc. are merely selected for convenience of explanation. Therefore, the disclosure is not limited to these terms and other terms having technically equivalent meanings may also be used.

In the following descriptions, a physical channel and a signal may be interchangeably used with data or a control signal. For example, a physical downlink shared channel (PDSCH) is a term indicating a physical channel through which data is transmitted, but the PDSCH may be used to indicate data. That is, in the disclosure, an expression ‘transmitting a physical channel’ may be interpreted as an expression ‘transmitting data or a signal through a physical channel.’

In the following disclosure, higher signaling refers to a signal transmission method for transmitting, by a base station, signals to a terminal by using a downlink data channel of a physical layer, or for transmitting, by a terminal, signals to a base station by using an uplink data channel of a physical layer. The higher signaling may be understood as radio resource control (RRC) signaling or a medium access control (MAC) control element (CE).

For convenience of explanation below, the disclosure uses terms and names defined in the 3rd Generation Partnership Project (3GPP) New Radio (NR) or 3rd Generation Partnership Project (3GPP) long term evolution (LTE) communication standards. However, the disclosure is not limited to these terms and names and may be equally applied to systems conforming to other standards. In the disclosure, a gNB may be used interchangeably with an eNB to ease the description. That is, the base station described as the eNB may indicate the gNB. In addition, the terminal may indicate a mobile phone, an MTC device, an NB-IoT device, a sensor or other wireless communication devices.

In the following description, a base station is an entity that allocates resources to terminals, and may be at least one of a gNode B (gNB), an eNode B (eNB), a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. Also, it is apparent that examples of the base station and the terminal are not limited thereto.

Particular, the disclosure is applicable to 3GPP NR (5th generation mobile communication standard). Also, the disclosure is applicable to intelligent services (e.g., smart home, smart building, smart city, smart car or connected car, healthcare, digital education, retail trade, security, and safety services) based on 5th communication technologies and IoT-related technologies. In the description, the term eNB may be interchangeably used with the term gNB for convenience of explanation. That is, a BS explained as an eNB may also indicate a gNB. The term UE may also indicate a mobile phone, NB-IoT devices, sensors, and other wireless communication devices.

Wireless communication systems providing voice-based services are being developed to broadband wireless communication systems providing high-speed and high-quality packet data services according to communication standards such as high speed packet access (HSPA), long term evolution (LTE) or evolved universal terrestrial radio access (E-UTRA), LTE-advanced (LTE-A), LTE-pro of 3GPP, high rate packet data (HRPD) and ultra mobile broadband (UMB) of 3GPP2, and 802.16e of the IEEE.

As a representative example of the broadband wireless communication systems, LTE systems employ orthogonal frequency division multiplexing (OFDM) for a downlink (DL), and employs single carrier-frequency division multiple access (SC-FDMA) for an uplink (UL). The UL refers to a radio link for transmitting data or a control signal from a user equipment (UE) (or a mobile station (MS)) to a base station (e.g., a BS or an eNB), and the DL refers to a radio link for transmitting data or a control signal from the BS to the UE. The above-described multiple access method enables data or control information of each user to distinguish by allocating and operating data or control information so that time-frequency resources to carry data or control information for each user do not overlap each other, that is, so that orthogonality is established.

A 5G communication system as a future communication system after LTE should support services that satisfy various requirements so that various requirements of users and service providers may be freely reflected. Services considered for the 5G communication system include enhanced mobile broadband (eMBB), massive machine type communication (mMTC), ultra reliability low latency communication (URLLC), and the like.

According to some embodiments, the eMBB aims to provide more improved data transfer rates than data transfer rates supported by existing LTE, LTE-A, or LTE-Pro. For example, in the 5G communication system, the eMBB should be able to provide a peak data rate of 20 Gbps in a downlink and a peak data rate of 10 Gbps in an uplink from the viewpoint of one base station. In addition, the 5G communication system should provide not only a peak data rate but also an increased user perceived data rate of the terminal. In order to satisfy such requirements, the 5G communication system requires to improve various transmission and reception technologies, including more advanced multi-input and multi-output (MIMO) transmission technology. Further, it is possible to satisfy a data transmission speed required by the 5G communication system by using a frequency bandwidth wider than 20 MHz in a frequency band of 3 to 6 GHz or 6 GHz or more while transmitting signals using up to 20 MHz transmission bandwidth in the 2 GHz band used by the current LTE.

At the same time, the mMTC is considered for the 5G communication systems to support application services such as the internet of things (IoT). The mMTC may be required to, for example, support massive UE access within a cell, enhance UE coverage, increase battery time, and reduce UE charges, to efficiently provide the IoT service. The IoT service provides a communication function by using a variety of sensors and being attached to various devices, and thus needs to support a large number of UEs within a cell (e.g., 1,000,000 UEs/km2). In addition, because UEs supporting mMTC may be located in a shadow zone not covered by cells, e.g., a basement of a building, due to service characteristics, the mMTC may require a wider coverage compared to other services provided by the 5G communication systems. The UEs supporting mMTC need to be low-priced, and are not able to frequently replace batteries and thus require a very long battery life time, e.g., 10 to 15 years.

Lastly, the URLLC is a mission-critical cellular-based wireless communication service and may be used for services used for remote control of robots or machinery, industrial automation, unmanned aerial vehicles, remote healthcare, emergency alert, etc. Thus, URLLC communication may provide a very low latency (ultra-low latency) and a very high reliability (ultra-reliability). For example, the URLLC service needs to satisfy an air interface latency less than 0.5 millisecond (ms) and, at the same time, may require a packet error rate equal to or less than 10-5. Therefore, for the URLLC service, the 5G systems need to provide a smaller transmit time interval (TTI) compared to other services and, at the same time, may have design requirements to allocate wide resources in a frequency band to ensure reliability of a communication link.

The above-described three services considered for the 5G systems, i.e., the eMBB, URLLC, and mMTC services, may be multiplexed and provided by a single system. In this case, the respective services may use different transmission/reception schemes and different transmission/reception parameters to satisfy different requirements for the services. The above-described mMTC, URLLC, and eMBB services are merely examples and the types of services to which the disclosure is applicable are not limited thereto.

Although LTE, LTE-A, LTE Pro, or 5G (or NR, next generation mobile communication) systems are mentioned as examples of the disclosure in the following description, embodiments of the disclosure may also be applied to other communication systems having similar technical backgrounds or channel types. Furthermore, the embodiments of the disclosure may also be applied to other communication systems through partial modification without greatly departing from the scope of the disclosure based on determination of one of ordinary skill in the art.

With reference to FIG. 1, a wireless access network of a wireless communication system (hereinafter, a next-generation mobile communication system (New Radio, NR or 5G)) as illustrated includes a next-generation base station (new radio node B, hereinafter gNB) 1-10 and AMF (new radio core network) 1-05. A new radio user equipment (hereinafter, NR UE or UE) 1-15 accesses an external network through the gNB 1-10 and AMF 1-05.

In FIG. 1, the gNB 1-10 may correspond to an evolved node B (eNB) 1-30 of the existing LTE system. Each gNB 1-10 may be connected to the NR UE 1-15 through radio channels and may provide superior services than the existing node B (1-20).

According to an embodiment of the disclosure, in the next-generation mobile communication system, since all user traffic is served through a shared channel, a device for scheduling by collecting status information, such as buffer status, available transmission power status, and channel status of UEs, and the gNB 1-10 serves as such a device. One gNB may typically control multiple cells.

According to an embodiment of the disclosure, in order to realize super-high data rates compared to the existing LTE system, the next-generation mobile communication system may have a bandwidth equal to or greater than the maximum bandwidth of the existing system, may employ, as wireless access technology, orthogonal frequency division multiplexing (hereinafter, referred to as “OFDM”), and may further employ a beamforming technique in addition thereto.

In addition, according to an embodiment of the disclosure, an adaptive modulation and coding (hereinafter, referred to as “AMC”) scheme may be applied to determine a modulation scheme and a channel coding rate in accordance with the channel status of a terminal. The AMF 1-05 may perform functions such as mobility support, bearer configuration, and QoS configuration. The AMF is a device that performs various control functions, as well as a mobility management function for a terminal, and may be connected to a plurality of base stations. In addition, the next-generation mobile communication system may interwork with the existing LTE system, and the AMF 1-05 is connected to an MME 1-25 through a network interface. The MME 1-25 is connected to the conventional base station, the eNB 1-30. A terminal that supports LTE-NR dual connectivity may transmit and receive data while maintaining connectivity to not only the gNB 1-10 but also the eNB 1-30 (1-35).

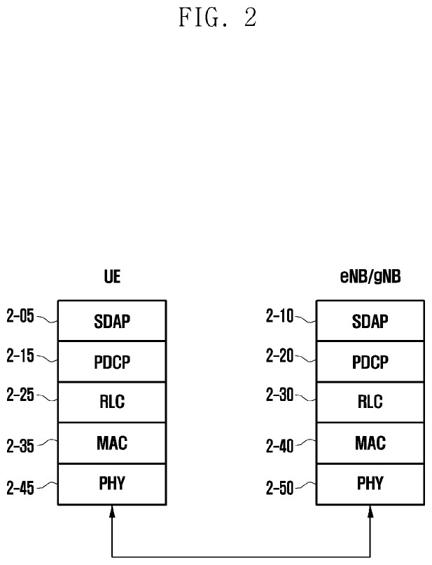

FIG. 2 illustrates a radio protocol architecture of an LTE system and NR system according to an embodiment of the disclosure.

With reference FIG. 2, the radio protocol architecture of the NR system may include service data adaptation protocol 2-05, 2-10, packet data convergence protocol 2-15, 2-20, radio link control (RLC) 2-25, 2-30, and medium access control (MAC) 2-35, 2-40 respectively for a UE and an gNB. The SDAP 2-05, 2-10 may perform an operation to map each QoS flow to a specific data radio bearer (DRB), and the SDAP configuration corresponding to each DRB may be provided from the upper layer (e.g., an RRC layer).

According to an embodiment of the disclosure, the PDCP 2-15, 2-20 may be in charge of operations, such as IP header compression and/or decompression, and may perform a re-ordering operation on data packets to provide in-order delivery service of data to an upper layer. Also, the RLC 2-25, 2-30 may reconstruct the PDCP PDU into an appropriate size. The MAC 2-35, 2-40 may be connected to a plurality of RLC layer devices constructed in one UE, and perform operations of multiplexing RLC PDUs to MAC PDUs and de-multiplexing RLC PDUs from MAC PDUs. The physical (PHY) layer 2-45, 2-50 may channel-code and modulate upper layer data to make orthogonal frequency division multiplexing (OFDM) symbols, and transmit them through a wireless channel, or demodulate the OFDM symbols received through the wireless channel, perform channel decoding, and transmit the OFDM symbols to upper layers.

In addition, according to an embodiment of the disclosure, hybrid automatic repeat request (HARQ) may be used for additional error correction in the PHY layer 2-45, 2-50, and a receiver may transmit whether the packet transmitted from a transmitter has been received with 1 bit. Information about whether the receiver receives the packet received from the transmitter may be referred to as HARQ ACK/NACK information.

In case of the LTE system, downlink HARQ ACK/NACK information for uplink data transmission may be transmitted through a physical Hybrid-ARQ indicator channel (PHICH). In case of the NR system, downlink HARQ ACK/NACK information for uplink data transmission may be transmitted through a physical dedicated control channel (PDCCH), which is a channel through which downlink and/or uplink resource allocation, etc. are transmitted. The base station may determine whether retransmission is necessary or new transmission may be performed through scheduling information of the UE.

Unlike the LTE system, the reason why the base station in the NR system determines whether retransmission is necessary or new transmission may be performed through the scheduling information of the UE may be because asynchronous HARQ is applied in the NR system. Uplink HARQ ACK/NACK information for downlink data transmission may be transmitted through a physical uplink control channel (PUCCH) or a physical uplink shared channel (PUSCH). The PUCCH may be transmitted in uplink of a primary cell (PCell) which will be described later. However, in a case where the base station is supported by the UE, the HARQ ACK/NACK information corresponding to a secondary cell (SCell) which will be described later may be transmitted. Here, the SCell may be referred to as a PUCCH SCell.

Although not illustrated in this drawing, a radio resource control (RRC) layer may exist in the upper layer of the PDCP layer of the UE and base station, and the RRC layer may exchange connection and measurement-related configuration control messages for radio resource control.

On the other hand, the PHY layer 2-45, 2-50 may include one or a plurality of frequencies and/or carriers, and a technology for simultaneously configuring and using a plurality of frequencies may be called carrier aggregation (hereinafter, CA) technology. The CA technology is a technology that in addition uses a primary carrier and one or more subcarriers instead of using only one carrier for communication between a UE and a base station (e.g., eNB or gNB), and the transmission amount may be increased by the number of subcarriers if the CA technology is used. On the other hand, in the LTE and NR systems, a cell within a base station using a primary carrier may be referred to as a primary cell or a PCell, and a cell within a base station using a subcarrier may be referred to as a secondary cell or SCell.

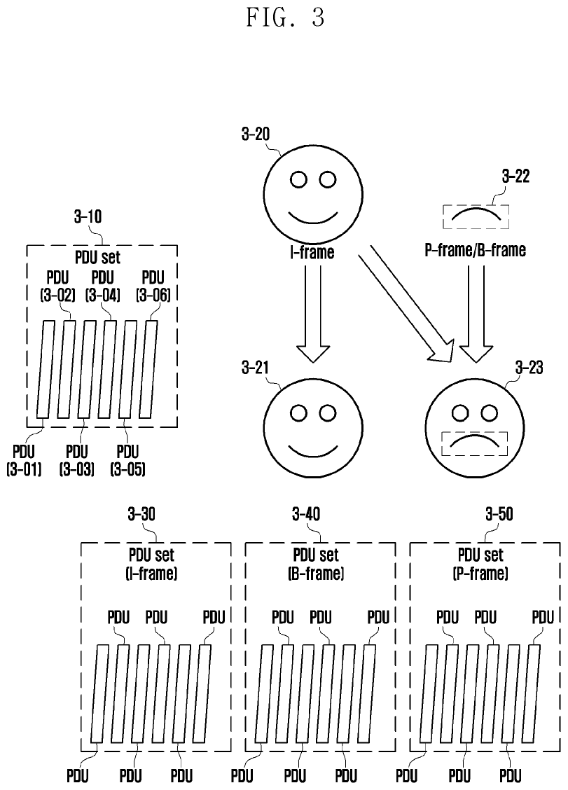

FIG. 3 illustrates a construction of a PDU set in an application data unit (ADU) according to an embodiment of the disclosure.

With reference to FIG. 3, various types of traffic may be divided into ADUs, which are units of information that may be classified at an application level. According to an embodiment, an ADU may be one photo or picture, one frame of video data, or one unit of audio data. The ADU may be divided into PDU set 3-10, and The PDU set 3-10 may be divided into at least one PDU 3-01, 3-02, 3-03, 3-04, 3-05, 3-06 depending on the size, and may be transmitted separately.

For example, in case where moving picture experts group (MPEG) standard video compression technology is used in video traffic, the PDU set may include at least one of 1) a combination 3-30 of multiple PDUs corresponding to one intra (I)-frame, 2) a combination 3-40 of multiple PDUs corresponding to one bidirectional (B)-frame, and 3) a combination 3-50 of multiple PDUs corresponding to one predicted (P)-frame.

According to an embodiment of the disclosure, the I-frame 3-20 is an independent frame and may represent one complete photo or picture 3-21 regardless of the presence or absence of other frames. The P-frame and B-frame 3-22 are frames indicating change information of the previous I-frame 3-20. If the I-frame 3-20 has not been received properly, it may be difficult to properly express a photo or picture that has been intended to be expressed as the P-frame and B-frame 3-22 (3-23). In addition, the B-frame is stored as data that estimates the movement between the two frames by with reference to both frames between the I-frame and the P-frame, so not only the I-frame in front but also the P-frame in the back may be received properly for the photo or picture intended to be expressed as the B-frame to be displayed normally.

In an embodiment of the disclosure, for ease of explanation, the construction of the PDU set may be explained with a case where MPEG standard video compression technology is used in video traffic as an example. However, the content of the disclosure is not limited to the PDU set construction in video traffic, and may be applied to all PDU set constructions including general ADU units.

According to an embodiment of the disclosure, an XR traffic flow for a specific extended reality (XR) service may include a combination of data (e.g., PDU, PDU set, etc.) with different quality of service (QOS) requirements. For example, when MPEG-coded video traffic is transmitted for a specific XR service, several types of PDU sets with different QoS requirements (e.g. delay, reliability, etc.) corresponding to I-frame/B-frame/P-frame may constitute one XR traffic flow.

According to an embodiment of the disclosure, in order to service the XR traffic flow consisting of data with various QoS requirements, a network may map the XR traffic flow to one or more QoS flows. As described above, in case where one or more QoS flows are used to service a specific XR traffic flow, data constituting the same XR traffic flow may be delivered through different QoS flows according to QoS requirements. In this case, different QoS flows may be mapped to different DRBs or to the same DRB. In addition, the PDU sets delivered through the same QoS flow may have different importances. For example, in the case of the video traffic, a PDU set corresponding to the I-frame may have relatively higher importance than a PDU set corresponding to the B-frame or P-frame. The importance of each PDU set may be expressed as a number from 0 to 8 or {True, false} or {0, 1}, etc. In the case of downlink data, UPF may include the above importance information in the GTP-U header. Also, the base station may consider the importance when transmitting the PDU set through the downlink. In addition, in the case of uplink, the importance information may be transmitted from the application layer of the UE to the lower layer (e.g., SDAP, PDCP, RLC, MAC) through the UE internal interface, or the importance information may be included in the SDAP/PDCP/RLC header, etc. For example, the MAC layer may identify the importance of data included in the RLC PDU through the RLC header information of the RLC PDU, and in this case, the importance of the data may ultimately be determined by the importance of the PDU set to which the corresponding data belongs.

The following embodiments of the disclosure has been described on the assumption that a lower importance value of a PDU set indicates higher importance, but the same method may be applied even in case where a higher importance value of a PDU set indicates higher importance. However, in this case, only the method of determining relative importance by comparing the importance values of respective PDU sets changes.

When network congestion occurs and the wireless resources in the network are not sufficient to transmit data waiting to be transmitted, the PDU set importance may be used to discard transmission of relatively low-importance data (in other words, in discarding low-importance data). By discarding low importance data packets, the base station and UE may secure radio resources necessary to transmit high-importance data packets. In the case of downlink data, a downlink packet discarding operation may be determined depending on base station implementation. On the other hand, an uplink packet discarding operation performed by the UE may be specified in the standard, and the UE may perform the packet discarding operation depending on the network configurations. Therefore, in the following embodiments of the disclosure, a method and apparatus for indicating the UE to discard uplink packets based on PDU set importance when the base station recognizes a network congestion situation.

The PDU set importance-based uplink packet discarding operation (hereinafter referred to as ‘PSI-based packet discarding operation’ for ease of explanation) may be performed for an uplink data packet (e.g., PDCP SDU/PDU, RLC SDU/PDU, MAC SDU/PDU), which is waiting to be transmitted at Layer 2 layer (e.g., MAC, RLC, PDCP layer) of the UE. In this case, the importance of each packet may be determined based on the importance of the PDU set to which the data included in the packet belongs. In the following embodiments of the disclosure, the packet discarding operation in the PDCP layer will be representatively described for ease of explanation. In this case, the unit performing the packet discarding operation may be a PDCP SDU or a PDCP PDU, and the entity performing the packet discarding operation may be the PDCP layer. However, the embodiments of the disclosure are not limited to the packet discarding operation in the PDCP layer, and the performance unit and performing entity of the packet discarding operation may vary depending on any one layer of the Layer 2 layers that perform the packet discarding operation. That is, the packet discarding operation may be performed in any one layer of the Layer 2 layers, and accordingly, at least one of the PDCP SDU, PDCP PDU, and RLC SDU, RLC PDU, and MAC SDU, MAC PDU is the target of the packet discarding operation.

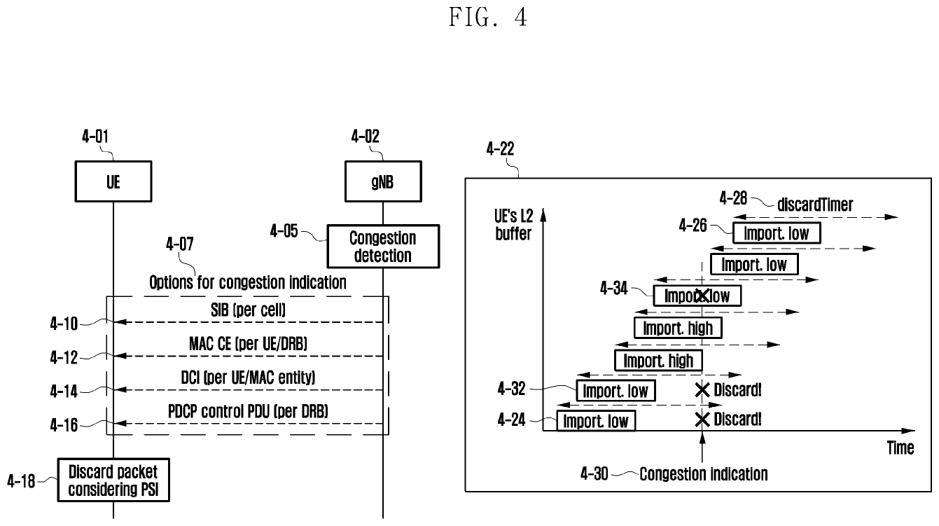

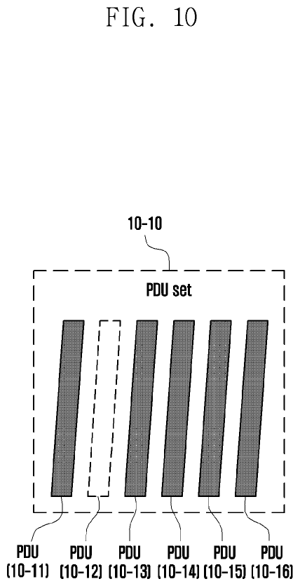

In addition, the above-described uplink packet discarding operation (PSI-based packet discarding operation) may be performed in units of PDU sets (in other words, in units of bundles of packets constituting the same PDU set) rather than in units of single packets. In the following embodiments (FIGS. 4, 5, 6, 7, and 8)) of the disclosure, a packet basis discarding operation (e.g., a PDCP SDU basis discarding operation) will be representatively described for ease of explanation. However, embodiments of the disclosure are not limited to the packet basis discarding operation, and may equally be applied to the PDU set basis discarding operation (PDU set discarding) as specifically described in FIG. 10 below. (However, in this case, operations described in packet units may be changed in PDU set units.)

FIG. 4 illustrates an operation and procedure in which the UE discards an uplink transmission packet based on PDU set importance according to a network indication according to an embodiment of the disclosure.

The gNB 4-02 may detect network congestion based on the status of schedulable wireless resources, etc. (4-05). In particular, in case where the gNB determines that uplink data of all UEs cannot be scheduled within a certain delay time due to insufficient uplink radio resources, the gNB may transmit a network congestion indicator 4-07 to the UE 4-01. The network congestion indicator may be defined as an indicator indicating a network congestion situation to the UE. In this case, the network congestion indicator may be used as an indicator that triggers various operations that the UE may perform when a network congestion situation occurs. Alternatively, the network congestion indicator may be defined as an indicator for instructing the UE to perform an uplink packet discarding operation based on PDU set importance (hereinafter referred to as PDU Set Importance, PSI, for ease of explanation). The following options may be considered as a method for transmitting the network congestion indicator.

### SIB (System Information Block) 4-10

The SIB may include an indicator to indicate network congestion. In this case, the gNB may transmit the network congestion indicator on a per-cell basis to the UEs within a cell coverage by broadcasting a SIB message. When the UE receives the network congestion indicator through the SIB message, the PSI-based packet discarding operation may be performed on all DRBs to which a PDU set is mapped (or all DRBs related to a PDU set) (e.g., a DRB to which a PDCP SDU with PSI information is mapped, a DRB configured to process PSI information, a DRB configured to handle packets on a per-PDU set basis, etc.) (4-18).

### MAC CE (MAC Control Element) 4-12

A new MAC CE may be defined to indicate network congestion. In this case, the gNB may transmit the network congestion indicator on a per-UE basis by transmitting the MAC CE to a specific UE. When the UE receives the network congestion indicator through the MAC CE, the PSI (packet importance)-based packet discarding operation may be performed on all DRBs to which a PDU set is mapped (or all DRBs related to a PDU set) (e.g., a DRB to which a PDCP SDU with PSI information is mapped, a DRB configured to process PSI information, a DRB configured to handle packets on a per-PDU set basis, etc.) (4-18).

In addition, the MAC CE may indicate one or a plurality of DRBs configured for the UE. In this case, the UE may perform the PSI-based packet discarding operation only for the DRB(s) indicated through the MAC CE (4-18).

In addition, in case where dual connectivity (DC) is configured, the UE may receive the MAC CE through MCG or SCG. For reference, in case DC is configured, three DRB types (MCG DRB, SCG DRB, and Split DRB) may exist. In this case, the UE may determine a target DRB to which the PSI-based packet discarding operation is used using at least one of the following methods.

### Option 1 (is Applied Regardless of DRB Type)

In case of receiving the MAC CE through MCG or SCG, the UE may activate or deactivate the PSI-based packet discarding operation for all DRBs to which the PDU set is mapped, regardless of DRB type.

### Option 2 (is Applied Differently Depending on DRB Type)

In case of receiving the MAC CE through MCG, the UE may activate or deactivate the PSI-based packet discarding operation for DRBs (MCG or split DRB) connected to the MCG RLC among all DRBs to which the PDU set is mapped.
In case of receiving the MAC CE through SCG, the UE may activate or deactivate the PSI-based packet discarding operation for DRBs (SCG or split DRB) connected to the SCG RLC among all DRBs to which the PDU set is mapped.

### Option 3 (is Applied Differently Depending on the Primary RLC of DRB)

In case of receiving the MAC CE through MCG, the UE may activate or deactivate the PSI-based packet discarding operation for split DRBs for which MCG DRB and MCG RLC are configured as a primary RLC among all DRBs to which a PDU set is mapped.
In case of receiving the MAC CE through SCG, the UE may activate or deactivate the PSI-based packet discarding operation for split DRBs for which SCG DRB and SCG RLC are configured as a primary RLC among all DRBs to which a PDU set is mapped.

### Option 4 (is Applied Differently Depending on the Secondary RLC of DRB)

In case of receiving the MAC CE through MCG, the UE may activate or deactivate the PSI-based packet discarding operation for split DRBs for which MCG DRB and MCG RLC are configured as a secondary RLC among all DRBs to which a PDU set is mapped.
In case of receiving the MAC CE through SCG, the UE may activate or deactivate the PSI-based packet discarding operation for split DRBs for which SCG DRB and SCG RLC are configured as a secondary RLC among all DRBs to which a PDU set is mapped.

### DCI (4-14)

A new DCI may be defined or an existing DCI may be used to indicate network congestion. In this case, the gNB may transmit the network congestion indicator on a per-UE basis by transmitting the DCI to a specific UE. When the UE receives the network congestion indicator through the DCI, the PSI-based packet discarding operation may be performed on all DRBs to which a PDU set is mapped (or all DRBs related to a PDU set) (e.g., a DRB to which a PDCP SDU with PSI information is mapped, a DRB configured to process PSI information, a DRB configured to handle packets on a per-PDU set basis, etc.)

Alternatively, when the UE receives the network congestion indicator through the DCI, the PSI-based packet discarding operation may be performed on DRBs that use cell group resources that have received the corresponding DCI (i.e., DRBs that are mapped to the RLC entity that uses the corresponding cell group resources), among the DRBs to which a PDU set is mapped (or the DRBs related to a PDU set) (e.g., a DRB to which a PDCP SDU with PSI information is mapped, a DRB configured to process PSI information, a DRB configured to handle packets on a per-PDU set basis, etc.) (4-18).

### PDCP Control PDU 4-16

A new PDCP control PDU may be defined to indicate network congestion. In this case, the gNB may transmit the network congestion indicator to a specific UE on a per-DRB basis by transmitting the PDCP control PDU through a specific DRB configured for the specific UE. When the UE receives the network congestion indicator through the PDCP control PDU, the UE may perform the PSI-based packet discarding operation on the DRB connected to the PDCP entity that has received the PDCP control PDU (4-18).

Reference numeral 4-22 in FIG. 4 shows the uplink packet discarding operation in the PDCP layer of the UE 4-01. When uplink data packets (e.g., PDCP SDU) arrive at the PDCP layer of the UE, the corresponding packets are stored in order in the Layer 2 (L2) buffer of the UE. In 4-22 of FIG. 4, the packet that has arrived first in the Layer 2 buffer is a packet 4-24, and the packet that has arrived last is represented by a packet 4-26. The PDCP layer may start a timer (discardTimer) for the packet discarding operation for each packet unit at the time the uplink data packet arrives. For example, with reference to FIG. 4, a discardTimer 4-28 may be started when packet 4-26 arrives. Expiration of the discardTimer may mean that transmission of the corresponding packet (e.g., PDCP SDU) is no longer valid. In other words, because the transmission delay time of the corresponding packet has exceeded a certain threshold, the receiver may no longer use the packet even if the receiver has received the corresponding packet. Therefore, the PDCP layer may discard a specific packet when the discardTimer associated with the corresponding packet expires.

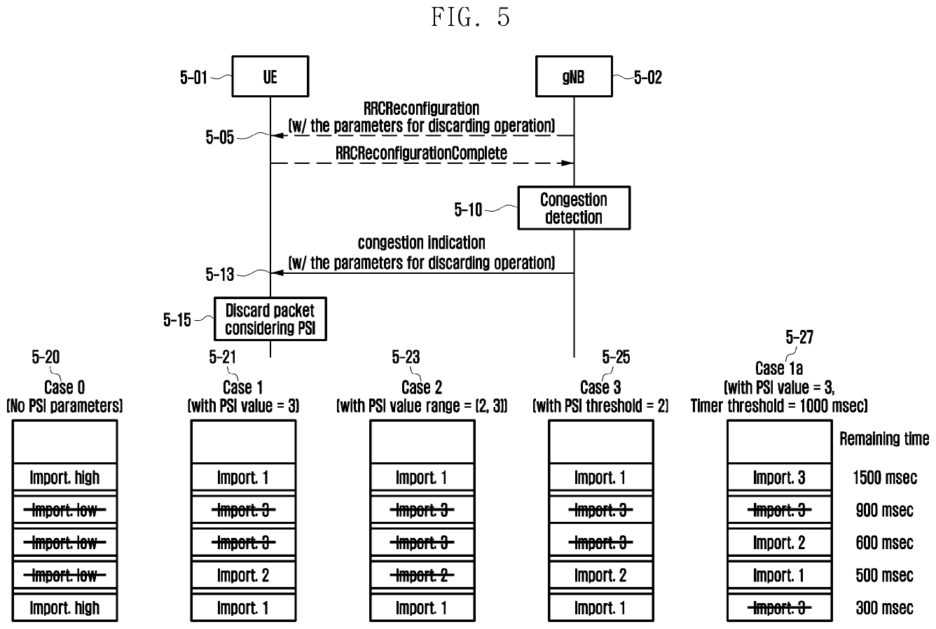

In case where the network congestion is indicated by at least one of the methods (4-10, 4-12, 4-14, 4-16) (4-30), the UE may perform the PSI-based packet discarding operation separately from the discardTimer-based packet discarding operation. When network congestion is indicated by the network (4-30), the UE may immediately discard the less important packets 4-24, 4-32, 4-34, among the uplink packets waiting to be transmitted in the Layer 2 buffer at that time, regardless of whether the discardTimer has expired or not. In this case, the importance value of each packet (e.g., PDCP SDU) may be the importance value (in other words, PSI) of the PDU set constituted by the data included in the corresponding packet. In FIG. 4, for ease of explanation, it is assumed that the PSI value has two values, such as {1, 0}, {true, false}, and {high, low}. However, in case where the PSI value is defined as a more diverse value, such as an integer from 0 to 8, parameters for indicating which packets with PSI values the UE will discard when performing the PSI-based packet discarding operation may be newly defined and configured by the base station. The corresponding operation will be described in detail in the embodiment of FIG. 5 below.

As described above, in case of network congestion, the gNB indicates the UE to perform the PSI-based packet discarding operation through the network congestion indicator, thereby indicating the UE to discard low-importance packets and use limited uplink transmission resources for high-importance packets. This operation may help improve users' satisfaction with XR service quality by enabling transmission of high-importance packets even in case where network congestion occurs.

FIG. 5 illustrates various operation methods and procedures in which the UE discards an uplink transmission packet based on PDU set importance according to a network indication according to an embodiment of the disclosure.

The PSI-based packet discarding operation described in FIG. 4 assumes only the case where the PSI value has two values, such as {1, 0}, {true, false}, and {high, low}. In this case, the gNB 5-02 may only indicate whether or not there is network congestion through the network congestion indicator without any additional configuration parameters, and the UE 5-01 may discard low-importance packets through the PSI-based packet discarding operation as in Case 0 (5-20) of FIG. 5. However, PSI values may be defined to have more diverse values, such as values between 0 and 8. In this case, when the UE 5-01 performs the PSI-based packet discarding operation according to the network congestion indication of the gNB 5-02, the following variables may be additionally transmitted from the gNB to the UE to specifically indicate which packets with PSI values to discard. Meanwhile, hereinafter, the case where the PSI value has a value between 0 and 8 will be described as an example, but the embodiment of the disclosure is not limited thereto. The PSI value may have a wide range of values depending on the criteria for classifying importance, such as values between 0 and 1 (same as described above), values between 0 and 3, and values between 0 and 15.

### PSI Value (or List of PSI Values)

For the PSI-based packet dropping operation, the PSI value or list of PSI values on which the packet discarding operation may be performed may be delivered to the UE. In this case, as in Case 1 (5-21), the UE may perform the packet discarding operation on packets having PSI values or PSI values included in the list of PSI values, which are configured by the gNB.

### Range of PSI Values

For the PSI-based packet discarding operation, the range of PSI values in which the packet discarding operation may be performed may be communicated to the UE. In this case, as in Case 2 (5-23), the UE may perform the packet discarding operation on packets with PSI values within the range (2 to 3) of the PSI value configured by the gNB.

### PSI Threshold

For the PSI-based packet discarding operation, the threshold value of the PSI value at which the packet discarding operation may be performed may be delivered to the UE. In this case, as in Case 3 (5-25), the UE may perform a packet discarding operation on packets with a PSI value higher or lower than the PSI threshold (2) set by the gNB. In the 5-25 example, it is assumed that the lower the PSI value, the higher the importance, and the example shows that packets with a PSI value (3) higher than the set threshold (2) are discarded.

### Timer Threshold

When performing the PSI-based packet discarding operation, packets that have just arrived in the Layer 2 buffer of the UE (i.e., packets with a large remaining time value (time remaining until the discardTimer expires) may be excluded from the packet discarding operation. To this end, the gNB may transmit a timer threshold to the UE along with the above-described PSI-related variables (at least one of PSI value/list, PSI range, and PSI threshold). Case 1a (5-27) represents a case where the gNB configures the timer threshold (1000 msec) along with the PSI value (3). In this case, among packets with a PSI value of 3, the UE may only discard packets whose remaining time (time remaining until the discardTimer expires) value is less than the timer threshold.

The gNB may use one of the following two options to configure at least one of the variables (e.g., PSI value/list, PSI range, PSI threshold, timer threshold) to the UE.
Option 1: The gNB may configure the variables necessary for the PSI-based packet discarding operation for the UE through an RRCReconfiguration message 5-05. In this case, when the gNB detects network congestion (5-10), the gNB may only transmit the network congestion indicator 5-13 to the UE without the need to transmit additional variables. After receiving the network congestion indicator in operation (5-13), the UE may perform the PSI-based packet discarding operation using the variables configured in operation 5-05 (5-15). In this case, as the network congestion indicator in operation 5-13, at least one or more of SIB 4-12, MAC CE 4-14, DCI 4-16, and PDCP control PDU 4-16 described in FIG. 4 may be used.
Option 2: When the gNB detects network congestion (5-10), the gNB may configure the variables necessary for the PSI-based packet discarding operation for the UE along with the network congestion indicator (5-13). In this case, as the network congestion indicator in operation 5-13, at least one or more of SIB 4-12, MAC CE 4-14, DCI 4-16, and PDCP control PDU 4-16 described in FIG. 4 may be used. After receiving the network congestion indicator in operation 5-13, the UE may perform the PSI-based packet discarding operation using the variables configured with the corresponding indicator (5-15).

In addition, the gNB may indicate network congestion to the UE in operation 5-13 and configure the DRB ID and LCID to which the PSI-based packet discarding operation will be applied.

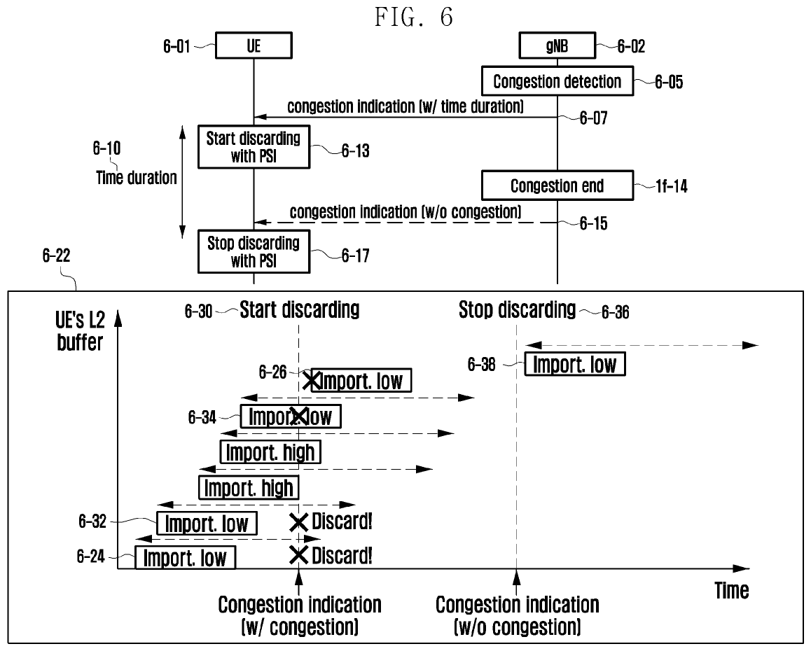

FIG. 6 illustrates an operation and procedure in which the UE discards a PDCP SDU based on PDU set importance for a specific time according to a network indication according to an embodiment of the disclosure.

When the gNB 6-02 detects network congestion (6-05), the gNB may share the network congestion situation with the UE 6-01 through the network congestion indicator 6-07 and indicates the PSI-based packet discarding operation. In this case, as the network congestion indicator in operation 6-07, at least one or more of SIB 4-12, MAC CE 4-14, DCI 4-16, and PDCP control PDU 4-16 described in FIG. 4 may be used. In the embodiment of FIG. 4, an operation of one-time discarding of the packets in the Layer 2 buffer based on the PSI value at the time the UE receives the network congestion indicator from the gNB has been described. However, considering that network congestion may generally last for more than a certain period of time once the congestion occurs, the gNB may configure the UE to continue the PSI-based packet discarding operation for a certain period of time when network congestion continues (or is expected to continue). To do this, at least one of the following two options may be used.
Option 1: In case where the gNB detects a network congestion situation (6-05) (or in case where the gNB detects a network congestion situation and the congestion situation is expected to last for a certain period of time), the gNB may also transmit a time duration value 6-10 for which the PSI-based packet discarding operation should be performed when transmitting the network congestion indicator to the UE (6-07). When the UE receives the network congestion indicator 6-07 along with a specific time duration value 6-10, the UE may start the PSI-based packet discarding operation (6-13) and continue to perform the PSI-based packet discarding operation for a specific time duration (6-10).
Option 2: The gNB may detect network congestion (6-05) and transmit the network congestion indicator 6-07 to the UE. When the UE receives the network congestion indicator 6-07, the UE may start the PSI-based packet discarding operation (6-13) and continue to perform the PSI-based packet discarding operation until the UE receives an indication 6-15 that network congestion has been resolved again from the gNB. Thereafter, the gNB may detect that the network congestion has been resolved (6-14) and indicate to the UE that the network congestion has been resolved (6-15). In this case, a method that does not include the indicator used as the network congestion indicator in operation 6-07 above may be used to indicate network congestion relief, or a method for defining a new indicator may be used to explicitly indicate network congestion relief. When the UE receives the indication 6-15 from the gNB indicating that network congestion has been resolved, the UE may stop the PSI-based packet discarding operation (6-17).

Through Option 1 or Option 2 described above, the UE may start the PSI-based packet discarding operation (6-30), and perform the PSI-based packet discarding operation for a certain period of time, and then finish the PSI-based packet discarding operation (6-31). When starting the PSI-based packet discarding operation, the UE may immediately discard low-importance packets 6-24, 6-32, 6-34, among the uplink packets waiting to be transmitted in the Layer 2 buffer at that time regardless of whether the discardTimer expires.

Thereafter, while maintaining the PSI-based packet discarding operation, when a new packet arrives, in case where the packet's importance is low (6-26), the UE may immediately discard the packet. For the packets that are not discarded among previously arrived packets and newly arrived packets, a discardTimer-based packet discarding operation (e.g., PDCP SDU discarding operation) may be performed as before. Thereafter, in case where the network congestion time duration configured by the gNB expires or an indication to resolve network congestion is received from the gNB, the UE may stop the PSI-based packet discarding and perform the discardTimer-based packet discarding operation on newly arrived packets as before, regardless of importance. In FIG. 6, for ease of explanation, it is assumed that the PSI value has two values, such as {1, 0}, {true, false}, and {high, low}. However, in case where the PSI value is defined as a more diverse value, such as an integer from 0 to 8, parameters for indicating which packets with PSI values the UE will discard when performing the PSI-based packet discarding operation may be newly defined and configured by the base station. The corresponding operation will be described in detail in the embodiment of FIG. 5 below.

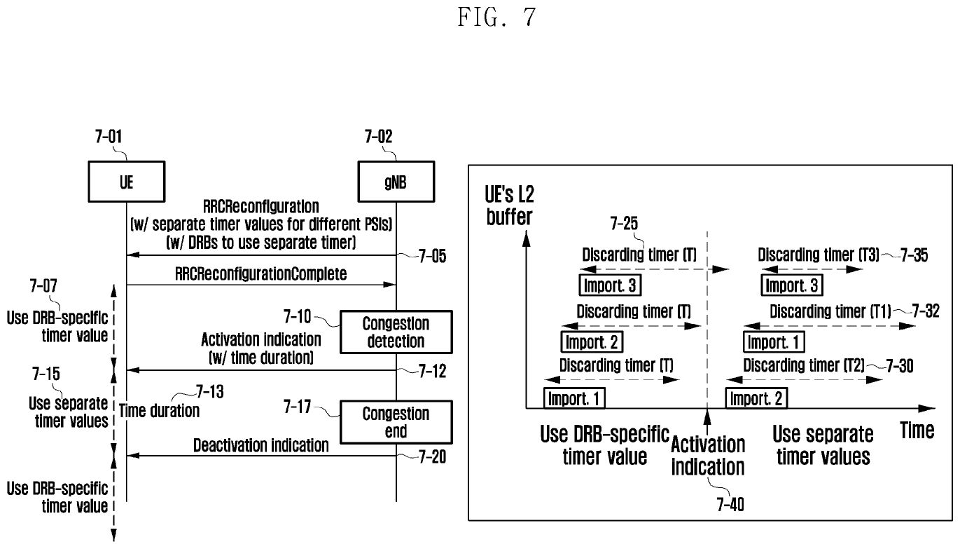

FIG. 7 illustrates an operation and procedure in which the UE uses a separate discarding timer value in units of PDU set importance according to a network indication according to an embodiment of the disclosure.

The PDCP layer of the UE 7-01 may perform a discarding timer-based PDCP SDU discarding operation as described in the embodiment of FIG. 4 above. Specifically, the PDCP layer of the UE may start the discardTimer 7-25 for the packet discarding operation on a per-packet basis when an uplink data packet (PDCP SDU) arrives, and may give up the transmission of the packet and discard the packet when the discardTimer for the packet expires. In this case, the discardTimer value is configured in units of PDCP entities connected to each DRB, and the same discardTimer value 7-25 may be used for all PDCP SDUs arriving at the corresponding DRB (PDCP entity). In this case, the discardTimer 7-25 may mean at least one discardTimer that starts before receiving an activation indication to use a separate discardTimer value according to importance in FIG. 7.

In addition when network congestion occurs, in order to discard low-importance packets relatively quickly and increase the transmission success rate of high-importance packets, separate discardTimer values 7-30, 7-32, 7-35 may be configured and used based on the importance of each packet during the PDCP SDU discarding operation. More specifically, a relatively short discardTimer value 7-35 may be configured for packets of relatively low importance, and a relatively long discardTimer value 7-32 may be configured for packets of relatively high importance. In this case, when transmission of uplink packets is delayed due to network congestion and the waiting time in the Layer 2 buffer of the UE becomes long, the discardTimer of relatively low-importance packets expires first, and the low-importance packets are discarded first, and thus, the likelihood that relatively high-importance packets will be transmitted successfully may increase.

The gNB 7-02 may configure (indicate) whether the UE 7-01 will use the same discardTimer value on a per-DRB basis (unit of the PDCP entity connected to the corresponding DRB) or separate discardTimer values depending on the importance of each uplink packet (7-40) based on the network congestion status. The specific respective operations are as follows.

In operation 7-05, the gNB may transmit an RRCReconfiguration message to the UE. The gNB may configure the discardTimer value to be used for PDCP SDU discarding operation through the RRC message. In this case, the gNB may configure one discardTimer value to be used on a per-DRB basis (unit of the PDCP entity connected to the corresponding DRB). In addition, the gNB may configure a separate discardTimer value based on importance of each packet on a per-UE basis or a per-DRB basis (unit of the PDCP entity connected to the corresponding DRB). For example, a separate discardTimer value may be configured for low-importance packets. Here, the packet may mean a PDCP SDU, and the importance of each packet may be the importance (PSI) value of the PDU set constituted by the data included in the packet. In addition, the gNB may configure (indicate) whether a separate discardTimer value may be used for each packet importance according to the network congestion situation on a per-DRB basis (unit of the PDCP entity connected to the corresponding DRB). At least one of the above-described configuration information may be configured to the UE through the RRCReconfiguration message. That is, at least one of the discardTimer value to be used on a per-DRB basis, the discardTimer value configured on a per-UE basis or per-DRB basis for each packet importance, and the information indicating whether a separate discardTimer value may be used for each packet importance may be configured to the UE through one RRCReconfiguration message.

In operation 7-07, the UE may perform the PDCP SDU discarding operation using one discardTimer value configured on a per-DRB basis (unit of the PDCP entity connected to the corresponding DRB) in operation 7-05 above. Therefore, the same discardTimer value is applied to all uplink packets arriving at the PDCP entity connected to the corresponding DRB.

In operation 7-10, the gNB may detect that a network congestion situation has occurred.

In operation 7-12, the gNB may transmit (configure) an indicator for activating an operation in which the UE uses a separate discardTimer value according to the importance of each packet. Alternatively, the indicator may be defined to be used as an indicator that triggers various operations that the UE perform when a network congestion situation occurs. As the indicator, at least one of MAC CE, DCI, and PDCP control PDU may be used in the manner described in FIG. 4, and at least one of the following variables may be included.
Time duration (7-13): A time value for which the UE may use a separate discardTimer value depending on the importance of the packet may be included. In case where the Time duration value is also configured in operation 7-12, the UE may maintain the operation of using a separate discardTimer value according to the importance of each packet for the Time duration. In case where the Time duration value is not configured in operation 7-12, the UE may maintain the operation of using a separate discardTimer value according to the importance of each packet until the UE receives a deactivation instruction from the gNB as in operation 7-20 below.
discardTimer value for each importance: In case where a separate discardTimer value is not configured for each importance through RRC signaling in operation 7-05, the corresponding values may be configured in operation 7-12.
Target DRB ID to be activated: One or more ID values of target DRBs for which the UE activate the operation using a separate discardTimer value depending on the importance of each packet may be included.

Alternatively, the indicator may not include any additional information and may simply be an indicator indicating the start and end of a network congestion situation (or the activation and deactivation of the operation using a different discardTimer value for each packet importance). For example, assuming that MAC CE is used as the indicator in operation 7-12, zero size MAC CE (MAC CE without payload of MAC CE itself) may be defined, and the activation or deactivation of the operation of using different discardTimer values according to packet importance may be indicated in network congestion situations using only the (e) LCID. In this case, in network congestion situations, MAC CEs are separately defined to activate and deactivate the operation of using different discardTimer values for each packet importance, and the two MAC CEs may be classified through the (e) LCID of each MAC CE. The UE, which has received one of the two MAC CEs, may simultaneously activate or deactivate the operation of using different discardTimer values for each packet importance for all DRBs configured (indicated) to use different discardTimer values for each packet importance in a network congestion situation (or all DRBs for which separate discardTimer values are configured for each packet importance) in operation 7-05 above.

In addition, in case where dual connectivity (DC) is configured, the UE may receive a MAC CE that indicates the start and end of a network congestion situation (or activation and deactivation of the operation of using different discardTimer values for each packet importance) through MCG or SCG. For reference, in case where DC is configured, three DRB types (MCG DRB, SCG DRB, and Split DRB) may exist. In this case, the UE may determine a target DRB to which activation and deactivation of the operation of using different discardTimer values for each packet importance will be applied using at least one of the following methods.

### Option 1 (is Applied Regardless of DRB Type)

When receiving the MAC CE through MCG or SCG, the UE may activate or deactivate the operation of using different discardTimer values for each packet importance for all DRBs for which separate discardTimer values are configured for each packet importance, regardless of DRB type.

### Option 2 (is Applied Differently Depending on DRB Type)

In case of receiving the MAC CE through MCG, the UE may activate or deactivate the operation of using different discardTimer values for each packet importance for DRBs connected to the MCG RLC (MCG or split DRB) among DRBs for which separate discardTimer values are configured for each packet importance.
In case of receiving the MAC CE through SCG, the UE may activate or deactivate the operation of using different discardTimer values for each packet importance for DRBs (SCG or split DRB) connected to the SCG RLC.

### Option 3 (is Applied Differently Depending on the Primary RLC of DRB)

In case of receiving the MAC CE through MCG, the UE may activate or deactivate the operation of using different discardTimer values for each packet importance for split DRBs in which MCG DRB and MCG RLC are configured as the primary RLC, among DRBs for which separate discardTimer values are configured for each packet importance.
In case of receiving the MAC CE through SCG, the UE may activate or deactivate the operation of using different discardTimer values for each packet importance for split DRBs in which SCG DRB and SCG RLC are configured as the primary RLC, among DRBs for which separate discardTimer values are configured for each packet importance.

### Option 4 (is Applied Differently Depending on the Secondary RLC of DRB)

In case of receiving the MAC CE through MCG, the UE may activate or deactivate the operation of using different discardTimer values for each packet importance for split DRBs in which MCG DRB and MCG RLC are configured as the secondary RLC, among DRBs for which separate discardTimer values are configured for each packet importance.
In case of receiving the MAC CE through SCG, the UE may activate or deactivate the operation of using different discardTimer values for each packet importance for split DRBs in which SCG DRB and SCG RLC are configured as the secondary RLC, among DRBs for which separate discardTimer values are configured for each packet importance.

In operation 7-17, the gNB may detect that network congestion has been resolved.

In operation 7-20, the gNB may transmit (configure), to the UE, an indicator for deactivating the operation of using separate discardTimer values for each packet importance. Alternatively, the indicator may be defined to be used as an indicator that triggers various operations that the UE may perform when resolving a network congestion situation. At least one of MAC CE, DCI, and PDCP control PDU may be used as the indicator, and at least one of the following variables may be included.
Target DRB ID to be deactivated: One or more ID values of target DRBs for which the UE may deactivate the operation of using a separate discardTimer value for each packet importance may be included.

Alternatively, the indicator may not include any additional information and may simply be an indicator indicating the start and end of a network congestion situation (or the activation and deactivation of the operation using a different discardTimer value for each packet importance). For example, assuming that MAC CE is used as the indicator in operation 7-20, zero size MAC CE (MAC CE without payload of MAC CE itself) may be defined, and the activation or deactivation of the operation of using different discardTimer values according to importance may be indicated in network congestion situations using only the (e) LCID. In this case, in network congestion situations, MAC CEs are separately defined to activate and deactivate the operation of using different discardTimer values for each packet importance, and the two MAC CEs may be classified through the (e) LCID of each MAC CE. The UE, which has received one of the two MAC CEs, may simultaneously activate or deactivate the operation of using different discardTimer values for each packet importance for all DRBs configured (indicated) to use different discardTimer values for each packet importance in a network congestion situation (or all DRBs for which separate discardTimer values are configured for each packet importance) in operation 7-05 above.

In addition, in case where dual connectivity (DC) is configured, the UE may receive the MAC CE that indicates the start and end of a network congestion situation (or activation and deactivation of the operation of using different discardTimer values for each packet importance) through MCG or SCG. For reference, in case where DC is configured, three DRB types (MCG DRB, SCG DRB, and Split DRB) may exist. In this case, the UE may determine a target DRB to which activation and deactivation of the operation of using different discardTimer values for each packet importance will be applied using at least one of the following methods.

### Option 1 (is Applied Regardless of DRB Type)

When receiving the MAC CE through MCG or SCG, the UE may activate or deactivate the operation of using different discardTimer values for each packet importance for all DRBs for which separate discardTimer values are configured for each packet importance, regardless of DRB type.

### Option 2 (is Applied Differently Depending on DRB Type)

In case of receiving the MAC CE through MCG, the UE may activate or deactivate the operation of using different discardTimer values for each packet importance for DRBs connected to the MCG RLC (MCG or split DRB) among DRBs for which separate discardTimer values are configured for each packet importance.
In case of receiving the MAC CE through SCG, the UE may activate or deactivate the operation of using different discardTimer values for each packet importance for DRBs (SCG or split DRB) connected to the SCG RLC.

### Option 3 (is Applied Differently Depending on the Primary RLC of DRB)

In case of receiving the MAC CE through MCG, the UE may activate or deactivate the operation of using different discardTimer values for each packet importance for split DRBs in which MCG DRB and MCG RLC are configured as the primary RLC, among DRBs for which separate discardTimer values are configured for each packet importance.
In case of receiving the MAC CE through SCG, the UE may activate or deactivate the operation of using different discardTimer values for each packet importance for split DRBs in which SCG DRB and SCG RLC are configured as the primary RLC, among DRBs for which separate discardTimer values are configured for each packet importance.

### Option 4 (is Applied Differently Depending on the Secondary RLC of DRB)

In case of receiving the MAC CE through MCG, the UE may activate or deactivate the operation of using different discardTimer values for each packet importance for split DRBs in which MCG DRB and MCG RLC are configured as the secondary RLC, among DRBs for which separate discardTimer values are configured for each packet importance.
In case of receiving the MAC CE through SCG, the UE may activate or deactivate the operation of using different discardTimer values for each packet importance for split DRBs in which SCG DRB and SCG RLC are configured as the secondary RLC, among DRBs for which separate discardTimer values are configured for each packet importance.

In addition, the gNB configures the discardTimer value for a specific packet importance to ‘0’ in the discardTimer configuration and indication in operations 7-05 and 7-12 above, so that the gNB may configure the UE to discard uplink packets (PDCP SDUs) with corresponding importance as soon as the uplink packets arrive at the PDCP layer.

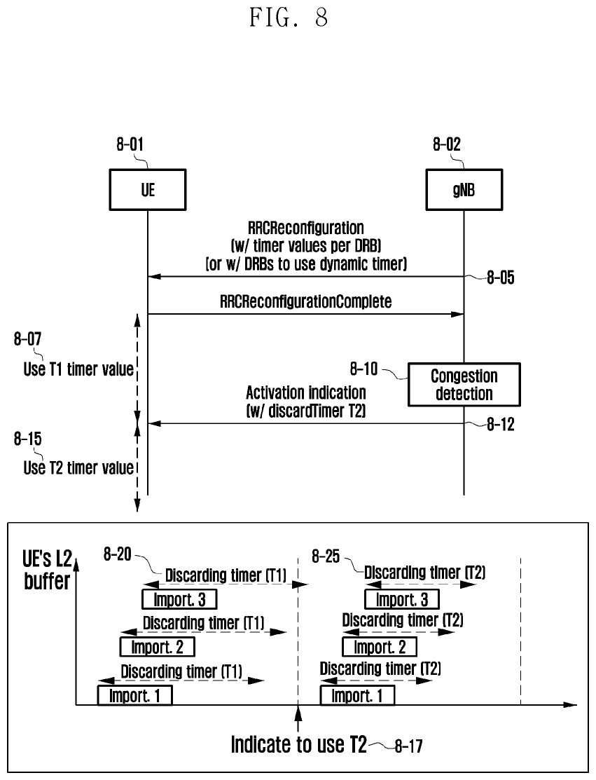

FIG. 8 illustrates an operation and procedure for changing a PDCP discarding timer value used in a PDCP layer for each DRB unit of the UE according to a network indication according to an embodiment of the disclosure.

The PDCP layer of the UE 8-01 may perform the discarding timer-based PDCP SDU discarding operation as described in the embodiment of FIG. 4 above. Specifically, the PDCP layer of the UE may start the discardTimer 8-20 for the packet discarding operation on a per-packet basis when an uplink data packet (PDCP SDU) arrives, and may give up and discard the transmission of the corresponding packet when the discardTimer for a specific packet expires. In this case, the discardTimer value is configured in units of PDCP entities connected to each DRB, and the same discardTimer value 8-20 may be used for all PDCP SDUs arriving at the corresponding DRB (PDCP entity).

In addition, when network congestion occurs, the gNB 8-02 may resolve the network congestion situation by having the UE 8-01 discard packets waiting to be transmitted relatively quickly. To do this, the gNB may configure one or more discardTimer values 8-20 and 8-25 for each DRB of the UE and indicate to use one of the values according to the network congestion situation (8-17). The specific step-by-step operations are as follows.

In operation 8-05, the gNB may transmit an RRCReconfiguration message to the UE. The gNB may configure the discardTimer value to be used for PDCP SDU discarding operation at the PDCP layer of the UE through the RRC message. In this case, the gNB may configure one or a plurality of discardTimer values to be used on a per-DRB basis (unit of the PDCP entity connected to the corresponding DRB). In this case, in case where a plurality of discardTimer values is configured for a specific DRB, each discardTimer value may be linked to a specific ID (or index) value and configured in the form of a list. Therefore, the gNB may indicate (set) which value the UE should use among the plurality of discardTimer values configured on a per-DRB basis using an ID or index value.

Alternatively, the gNB may configure only two discardTimer values to be used on a per-DRB basis (unit of the PDCP entity connected to the corresponding DRB). In case where only two discardTimers are configured, one of them is a default value (i.e., a value used by default in the absence of additional configurations and indications) and the other may be a value that may be used in network congestion situations (i.e., a value that may be used according to the configuration and indication of the gNB in network congestion situations). In this case, the value that may be used in the network congestion situation may be applied only to a low-importance packet. Here, whether importance of a specific packet is low may be determined depending on UE implementation or based on a threshold configured by the gNB. In this way, in case where only two discardTimer values are configured on a per-DRB basis, they may be defined and classified as separate fields without using separate ID and index values. In addition, the gNB may configure (indicate) on a per-DRB basis (unit of the PDCP entity connected to the DRB) whether the discardTimer value of the corresponding DRB may be flexibly changed depending on the network congestion situation. In this embodiment, it is assumed that T1 8-20 is configured (indicated) to be used as the discardTimer value.

In operation 8-07, the UE may perform the PDCP SDU discarding operation using the value (T1, 8-20) indicated to be used among one or a plurality of discardTimer values configured on a per-DRB basis (unit of the PDCP entity connected to the corresponding DRB) in operation 8-05 above. Therefore, the same discardTimer value (T1, 8-20) is applied to all uplink packets arriving at the PDCP entity connected to the corresponding DRB.

In operation 8-10, the gNB may detect that a network congestion situation has occurred.

In operation 8-12, the gNB may transmit (configure), to the UE, an indicator that indicates the UE to use a different discardTimer value for a specific DRB. Alternatively, the indicator may be defined to be used as an indicator that triggers various operations that the UE may perform when a network congestion situation occurs. As the indicator, at least one of MAC CE, DCI, and PDCP control PDU may be used in the manner described in FIG. 4, and at least one of the following variables may be included.
Target DRB ID to be activated: One or more ID values of the target DRB for which the UE activates the operation of changing the discardTimer value may be included.
discardTimer ID (or index): In case where a plurality of discardTimer values is configured on a per-DRB basis in operation 8-05 above, each discardTimer value may be configured with a specific ID (or index) value. The gNB may include the corresponding DRB ID and discardTimer ID (or index) value to indicate the UE to use (activate) one of the plurality of discardTimer values configured for a specific DRB in operation 8-05 above.

For example, assuming that MAC CE is used to indicate discardTimer activation in operation 8-12 above, 5 bits of the 8 bits constituting the corresponding MAC CE may indicate a specific DRB ID and the remaining 3 bits may be used to indicate one of the plurality of discardTimer values configured for the corresponding DRB in operation 8-05. In addition, in order to indicate the discardTimer value to be used in each DRB for the plurality of DRBs, the MAC CE may include a plurality of 8-bit information consisting of the DRB ID and the discardTimer ID value in a list form as described above. When the UE receives the MAC CE configured in the above form, the UE may start using the discardTimer value indicated for each DRB.

In addition, in case where only two discardTimer values are configured for each DRB in operation 8-05 above, a zero size MAC CE (MAC CE without payload of MAC CE itself) may be defined, and a discardTimer to be used in a network congestion situation using only (e) LCID may be activated or deactivated. In this case, MAC CEs for activating and deactivating the discardTimer value to be used in a network congestion situation are separately defined, and the two MAC CEs may be classified through the (e) LCID of each MAC CE. The UE, which has received one of the two MAC CEs, may simultaneously activate or deactivate the discardTimer value to be used in a network congestion situation for all DRBs configured (indicated) (or all DRBs for which two discardTimer values are configured) so that the discardTimer value may be changed flexibly according to the network congestion situation in operation 8-05 above.

In addition, in case where dual connectivity (DC) is configured, the UE may receive the MAC CE for activating or deactivating the discardTimer value to be used in a network congestion situation through MCG or SCG. For reference, in the DC situation, three DRB types (MCG DRB, SCG DRB, and Split DRB) may exist. In this case, the UE may determine a target DRB to which activation and deactivation of the discardTimer value to be used in a network congestion situation will be applied using at least one of the following methods.

### Option 1 (is Applied Regardless of DRB Type)

When receiving the MAC CE through MCG or SCG, the UE may activate or deactivate the discardTimer value to be used in a network congestion situation for all DRBs for which the discardTimer value is configured (indicated) to change flexibly regardless of the DRB type.

### Option 2 (is Applied Differently Depending on DRB Type)

In case of receiving the MAC CE through MCG, the UE may activate or deactivate the discardTimer value to be used in a network congestion situation for DRBs connected to the MCG RLC (MCG or split DRB).
In case of receiving the MAC CE through SCG, the UE may activate or deactivate the discardTimer value to be used in a network congestion situation for DRBs (SCG or split DRB) connected to the SCG RLC.

### Option 3 (is Applied Differently Depending on the Primary RLC of DRB)

In case of receiving the MAC CE through MCG, the UE may activate or deactivate the discardTimer value to be used in a network congestion situation for split DRBs in which MCG DRB and MCG RLC are configured as the primary RLC.
In case of receiving the MAC CE through SCG, the UE may activate or deactivate the discardTimer value to be used in a network congestion situation for split DRBs in which SCG DRB and SCG RLC are configured as the primary RLC.

### Option 4 (is Applied Differently Depending on the Secondary RLC of DRB)

In case of receiving the MAC CE through MCG, the UE may activate or deactivate the discardTimer value to be used in a network congestion situation for split DRBs in which MCG DRB and MCG RLC are configured as the secondary RLC.
In case of receiving the MAC CE through SCG, the UE may activate or deactivate the discardTimer value to be used in a network congestion situation for split DRBs in which SCG DRB and SCG RLC are configured as the secondary RLC.
discardTimer value for each DRB: In case where a plurality of discardTimer values for each DRB is not configured through RRC signaling in operation 8-05 above, a discardTimer value to be used in a specific DRB may be configured in operation 8-12. In other words, a specific DRB ID and a specific discardTimer value may be indicated. In this case, the UE may use the discardTimer value indicated for the corresponding DRB.

In operation 8-15, the UE may perform a PDCP SDU discarding operation using the changed discardTimer value for each DRB according to the indication in operation 8-12 above. The UE may apply the changed discardTimer (T2, 8-25) value for packets (PDCP SDUs) arriving after the gNB has indicated to change the discardTimer value for a specific DRB (or multiple DRBs) (8-17).

In addition, the gNB may configure the UE to immediately discard all uplink packets (PDCP SDUS) arriving at the PDCP layer of the corresponding DRB by configuring the discardTimer value for a specific DRB to ‘0’ in the discardTimer configuration and indication in operations 8-05 and 8-12 above.

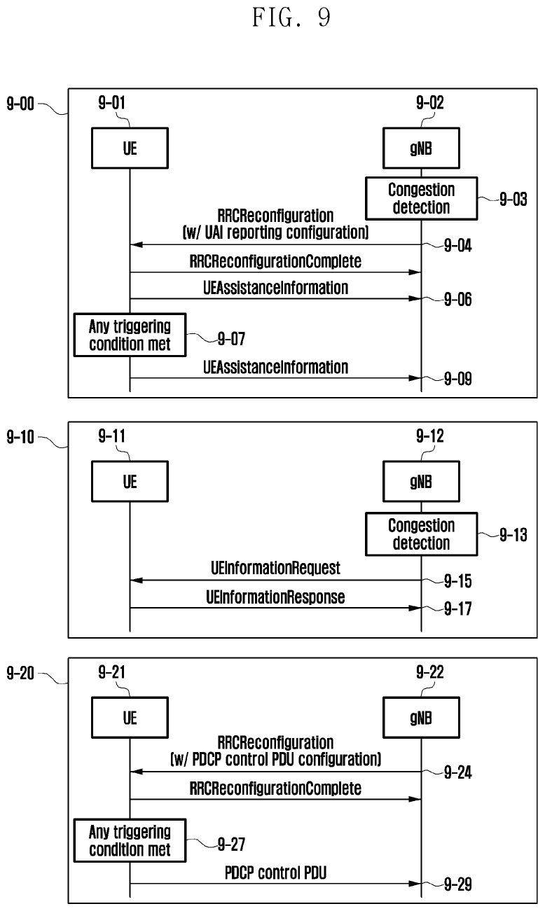

FIG. 9 illustrates a procedure in which the UE reports information about an uplink packet waiting to be transmitted to the base station to assist in indicating a PDCP discarding operation based on PDU set importance of a network according to an embodiment of the disclosure.

The UE 9-01, 9-11, 9-21 may report, to the gNB, information that may be helpful when the gNB 9-02, 9-12, 9-22 configures the packet discarding operation of the UE according to the configuration method of the packet importance (e.g., importance of the PDU set to which the data included in each packet belongs, PSI)-based packet discarding operation (e.g., PDCP SDU discarding) described in FIGS. 4, 5, 6, and 7 above. For reference, according to the current standard, since there is no method for the UE to determine the importance (e.g., PSI value) of packets transmitted through the uplink, the gNB has difficulty in configuring the packet importance-based packet discarding operation described in FIGS. 4, 5, 6, and 7. To solve this problem, the UE may provide the gNB with at least one of the following information (hereinafter referred to as ‘PSI-based UE assistance information’ for ease of explanation). For reference, PSI-based UE assistance information may be calculated (constituted) and reported in DRB/RLC/LCH units.

### Importance of Uplink Packets Waiting to be Transmitted at the UE (in Other Words, PSI)

A list of importance values (PSIs) of uplink packets (at least one of PDCP SDU/PDU, RLC SDU/PDU, and MAC SDU/PDU) waiting to be transmitted in the Layer 2 buffer of the UE may be reported to the gNB. For example, in case where uplink packets with importance 1, 2, and 3 are waiting for transmission in the Layer 2 buffer of the UE, the UE may report the importance values of the corresponding packets to the gNB in the form of a list. As another method, the UE may report to the gNB only the largest (or smallest) value among the importance values (PSIs) of uplink packets waiting to be transmitted in the Layer 2 buffer.

### Amount of Uplink Packets Waiting to be Transmitted for Each Importance Level

The amount of uplink packets waiting to be transmitted in the Layer 2 buffer of the UE may be reported by importance value (PSI). For example, the UE may add up the size of uplink packets waiting to be transmitted in the Layer 2 buffer by importance and report the size to the gNB. As another method, the UE may report to the gNB the proportion of packets with each importance value (PSI) among the total size of uplink packets waiting to be transmitted in the Layer 2 buffer. For example, when the total size of packets waiting to be transmitted in the Layer 2 buffer of the UE is 100 MB, if the total size of packets with an importance value of 1 is 30 MB, the total size of packets with an importance value of 2 is 20 MB, and the total size of packets with an importance value of 3 is 50 MB among the total size of packets, 30%, 20%, and 50% values for respective importances 1, 2, and 3 may be reported to the gNB.

### Whether QoS Requirements (e.g., PSER, PER, PSDB, PDB, Etc.) are Satisfied for Each Importance

The UE may report to the gNB whether the following QoS requirements are satisfied when transmitting an uplink packet with the corresponding importance for each importance value (PSI).
Packet Error Rate (PER)
Packet Delay Budget (PDB)
PDU Set Error Rate (PSER): defines an upper bound for a rate of non-congestion related PDU Set losses between RAN and the UE.
PDU Set Delay Budget (PSDB): time between reception of the first PDU (at the UPF in DL, at the UE in UL) and the successful delivery of the last arrived PDU of a PDU Set (at the UE in DL, at the UPF in UL). PSDB is an optional parameter and when provided, the PSDB supersedes the PDB.

### L2 Transmission Delay Time for Each Importance

The UE may measure an average delay time from when uplink packets with each importance value for each importance arrive at the Layer 2 buffer to when actual transmission is completed, and report the average delay time to the gNB.

Specifically, the PSI-based UE assistance information described above may be reported from the UE to the gNB by at least one of the following methods.
A method for using UE assistance Information (UAI) (9-00):

The gNB 9-02 may configure the UE 9-01 to report PSI-based UE assistance information using UAI. The UE may include the PSI-based UE assistance information in a UAI message according to the gNB configuration, and report the same.

In operation 9-03, the gNB may determine that a network congestion situation has occurred. The gNB may require the PSI-based UE assistance information to configure the PSI-based packet discarding operation depending on the network congestion situation. Therefore, the gNB may configure the UE to report the PSI-based UE assistance information through the UAI message in operation 9-04 below. More specifically, at least one of the following variables may be included in the corresponding configuration information.
prohibitTimer: A separate prohibitTimer value may be configured to prevent the UE from reporting PSI-based UE assistance information through the UAI message too frequently. The UE cannot transmit a new UAI message for reporting the PSI-based UE assistance information while the prohibitTimer configured in relation to the PSI-based UE assistance information is running.
Reporting condition configuration: Variables related to the conditions for triggering the UE to report the PSI-based UE assistance information may be configured. For example, in case where the gNB wants to periodically receive the PSI-based UE assistance information from the UE, a reporting period may be configured. As another example, in case where the gNB wants to receive the PSI-based UE assistance information when the delay time experienced by uplink packets in the Layer 2 buffer of the UE exceeds a certain threshold, the corresponding threshold may be configured.
Reporting information configuration: Variables indicating information to be included when the UE reports the PSI-based UE assistance information may be configured. For example, for each piece of information included in the PSI-based UE assistance information, an indicator may be included indicating whether the UE should include the information in a UAI message and report the same. In addition, the DRB/RLC/LCID, etc. to which the PSI-based UE assistance information should be reported may be indicated.

In operation 9-06, if the UE has not yet transmitted the UAI message including the PSI-based UE assistance information after receiving the PSI-based UE assistance information reporting configuration through the UAI message in operation 9-04 above, the UE may trigger the transmission of the UAI message for reporting the PSI-based UE assistance information. The UE may report the PSI-based UE assistance information through the UAI message according to the gNB indication in operation 9-04.

In operation 9-07, the reporting conditions for the PSI-based UE assistance information through the UAI messages may be satisfied. The reporting conditions may be configured by the gNB as in the example described in operation 9-04 above. Alternatively, the standard may specify the PSI-based UE assistance information reporting conditions through the UAI. For example, in case where a PDCP SDU discarding operation occurs in the PDCP layer of a specific DRB of the UE and there is the PSI-based UE assistance information measured (or calculated) for the DRB, the UE may trigger the transmission of the UAI message for reporting the PSI-based UE assistance information.

In operation 9-09, the UE may transmit the UAI message triggered in operation 9-07 to report the PSI-based UE assistance information. However, in case where prohibitTimer configured for the PSI-based UE assistance information reporting is running, the corresponding UAI transmission may be delayed.
A method for using UE information request/response (9-10):

The gNB 9-12 may request the UE 9-13 to report the PSI-based UE assistance information through a UE information response message through a UE information request message. The UE may respond in response to the gNB request by including the PSI-based UE assistance information in the UE Information Response message.

In operation 9-13, the gNB may determine that a network congestion situation has occurred. The gNB may require the PSI-based UE assistance information to configure the PSI-based packet discarding operation depending on the network congestion situation. Therefore, the gNB may request the UE to report the PSI-based UE assistance information through the UE information response message through the UE information request message in operation 9-15 below.

In operation 9-15, the gNB may request the UE to report the PSI-based UE assistance information through the UE information response message through the UE information request message. More specifically, at least one of the following variables may be included in the UE information request message.
Reporting information configuration: Variables indicating information to be included when the UE reports the PSI-based UE assistance information may be configured. For example, for each piece of information included in the PSI-based UE assistance information, an indicator may be included indicating whether the UE should include the corresponding information in the UE information response message and report the same. In addition, the DRB/RLC/LCID, etc. to which the PSI-based UE assistance information should be reported may be indicated.

In operation 9-17, the UE may trigger transmission of the UE information response message to report the PSI-based UE assistance information after receiving a request to report the PSI-based UE assistance information through the UE information request message in operation 9-15 above. The UE may report the PSI-based UE assistance information through the UE information response message in response to the gNB indication in operation 9-15 above.

### A Method for Using PDCP Control PDU (9-20):

The gNB 9-22 may configure the UE 9-23 to report the PSI-based UE assistance information using a PDCP control PDU, and the UE may transmit the PDCP control PDU including the PSI-based UE assistance information according to the gNB configuration.

In operation 9-24, the gNB may configure the UE to report the PSI-based UE assistance information through the PDCP control PDU. In this case, the DRB/RLC/LCID, etc. to which the PDCP control PDU including the PSI-based UE assistance information should be transmitted may also be indicated.

In operations 9-27, the transmission condition of the PDCP control PDU including the PSI-based UE assistance information may be satisfied. The above reporting condition may be specified in the standard. For example, in case where a PDCP SDU discarding operation occurs in the PDCP layer of a specific DRB of the UE, transmission of the PDCP control PDU including the PSI-based UE assistance information to the gNB may be triggered in the PDCP entity of the corresponding DRB of the UE.

In operation 9-29, the UE may transmit the PDCP control PDU including the PSI-based UE assistance information triggered in operation 9-27 above.

FIG. 10 illustrates a PDU set discarding operation method in a PDCP layer according to an embodiment of the disclosure.

The discardTimer-based uplink packet discarding operation (in other words, PDCP SDU discarding operation) described in the embodiments of FIGS. 4, 5, 6, 7, and 8 may be performed on a per-PDU set basis rather than a single packet basis (e.g., PDCP SDU/PDU). The specific PDU set unit packet discarding (in other words, PDU set discarding) operation method is as described below.

With reference to FIG. 10, when a specific PDU 10-12 among the PDUs constituting the PDU set 10-10 is discarded due to expiration of the discardTimer, the PDCP layer of the UE may perform a PDU set discarding operation that discards the remaining PDUs 10-11, 10-13, 10-14, 10-15, 10-16 constituting the PDU set for efficient use of radio resources. In this case, the remaining PDUs may mean ‘PDUs that have not yet been transmitted’ or ‘PDUs with a higher sequence number (SN) than the discarded PDU’ among the PDUs constituting the PDU set. In addition, the ‘PDU set’ and ‘PDU’ may mean a PDU in an upper layer of the PDCP layer, and a PDCP SDU in the PDCP layer. In case where any one PDU of the PDU set is discarded and transmission of the PDU set is no longer meaningful, PDU set discarding operation (or ADU discarding) may enable efficient use of radio resources by discarding other PDUs belonging to the PDU set.

The PDU set discarding operation may be configured on a per-DRB basis. To configure the PDU set discarding operation, 1-bit indicators such as ‘PDU_SetDiscardEnabled’, ‘PDU_SetDiscard’, ‘ADU_DiscardEnabled’, ‘ADU_Discard’, etc. may be newly defined in the PDCP-Config of the DRB. The base station may configure the PDU set discarding operation for a specific DRB through a newly defined indicator in the PDCP-Config of the DRB. In addition, the base station may transmit the IDs of DRBs that may need to perform a PDU set discarding operation to the UE in the form of a list, and the UE may perform the PDU set discarding operation in the PDCP entity corresponding to the DRBs.

In addition, the base station may configure the PDU set discarding operation on a per-UE basis instead of configuring the PDU set discarding operation on a per-DRB basis. In case of configuring the PDU set discarding operation on a per-UE basis, the base station may transmit a 1-bit indicator as ‘PDU_SetDiscardEnabled’, ‘PDU_SetDiscard’, ‘ADU DiscardEnabled’, ‘ADU_Discard’, etc. to configure the PDU set discarding operation to a specific UE. Therefore, the UE, which has received the 1-bit indicator, may perform the PDU set discard operation for the DRBs that are configured with discardTimer and have received configuration information about the PDU set (e.g., PDU set index information) from the upper layer, with respect to all DRBs configured in the UE.

The discardTimer operation method in the PDCP layer may vary depending on whether the PDU set discarding operation is necessary. In case where the PDUs (i.e. PDCP SDUs) constituting the PDU set for which the PDU set discarding operation may be performed arrive at the PDCP layer, the PDCP entity may operate a discardTimer on a per-PDU set basis to perform the PDU set discarding operation on a per-PDU set basis.

Specifically, the PDCP entity may start the discardTimer corresponding to the corresponding PDU set at the time a first PDU constituting the specific PDU set arrives at the PDCP layer. Thereafter, when the discardTimer corresponding to the PDU set expires, the PDCP entity may discard all PDUs (i.e., PDCP SDUs) constituting the corresponding PDU set. On the other hand, in case where the PDUs (i.e., PDCP SDUs) constituting a PDU set that do not perform the PDU set discarding operation arrive at the PDCP layer, the PDCP entity may operate a discardTimer for each PDU (i.e., PDCP SDU) unit, regardless of the PDU set. Specifically, the PDCP layer may start the discardTimer corresponding to each PDU (i.e., PDCP SDU) at the time the corresponding PDU arrives at the PDCP layer. Thereafter, when the discardTimer corresponding to each PDU expires, the PDCP layer may discard the corresponding PDU. This operation may be reflected in the PDCP standard in at least one of the two options below. In case of using option 1 among the options below, as in the case of option 2, realistically only one discardTimer may run on a per-PDU set basis, while changes to the existing UE implementation that runs the discardTimer on a per-PDCP SDU basis may be minimized.

Option 1. As before, discardTimer is operated on a per-PDCP SDU basis. When a PDCP SDU

| | belonging to a specific PDU set arrives, in case where the discardTimer associated |
|---|---|
| | with another PDCP SDU belonging to the same PDU set is already running, the new |
| | PDCP SDU is associated with the existing discardTimer. |
| 5.2.1 | Transmit operation |

At reception of a PDCP SDU from upper layers, the transmitting PDCP entity shall:

| | |
|---|---|
| - | if ‘PDU_SetDiscardEnabled’, ‘PDU_SetDiscard’, ‘ADU_DiscardEnabled’, or |

‘ADU_Discard’ is configured for that PDCP entity:

| | |
|---|---|
| - | if the PDCP SDU has PDU set info (e.g., PDU set index) and there is any running |

discardTimer associated with any PDCP SDU having the same PDU set info:

- associate the (existing/running) discardTimer with this PDCP SDU.

- else:

- start the discardTimer associated with this PDCP SDU (if configured).

- else:

| | |
|---|---|
| | -start the discardTimer associated with this PDCP SDU (if configured). |
| 5.3 | SDU discard |

When the discardTimer expires for a PDCP SDU, or the successful delivery of a PDCP SDU is
confirmed by PDCP status report, the transmitting PDCP entity shall discard the PDCP SDU
along with the corresponding PDCP Data PDU. When the discardTimer associated with
multiple PDCP SDUs expires, the transmitting PDCP entity shall discard all the associated
PDCP SDUs with the corresponding PDCP Data PDUs. If the corresponding PDCP Data PDU
has already been submitted to lower layers, the discard is indicated to lower layers.
Option 2: Operates discardTimer on a per-PDU set basis. When a PDCP SDU belonging to a

| | |
|---|---|
| | specific PDU set arrives, in case where there is no discardTimer associated with the |
| | corresponding PDU set, a new discardTimer is started and association is performed |
| | to the PDU set. |
| 5.2.1 | Transmit operation |

At reception of a PDCP SDU from upper layers, the transmitting PDCP entity shall:

| | |
|---|---|
| - | if ‘PDU_SetDiscardEnabled’, ‘PDU_SetDiscard’, ‘ADU_DiscardEnabled’, or |

‘ADU_Discard’ is configured for that PDCP entity:

| | |
|---|---|
| - | if the PDCP SDU has PDU set info (e.g., PDU set index) and there is no running |

discardTimer associated with the PDU set:

- start the discardTimer associated with the PDU set (if configured).

```
  - else:
  -start the discardTimer associated with this PDCP SDU (if configured).
```

| | |
|---|---|
| 5.3 | SDU discard |

When the discardTimer expires for a PDCP SDU, or the successful delivery of a PDCP SDU is
confirmed by PDCP status report, the transmitting PDCP entity shall discard the PDCP SDU
along with the corresponding PDCP Data PDU. When the discardTimer expires for a PDU set,
the transmitting PDCP entity shall discard all the PDCP SDUs belonging to (associated with)
the PDU set along with the corresponding PDCP Data PDUs. If the corresponding PDCP Data
PDU has already been submitted to lower layers, the discard is indicated to lower layers.

In addition, even in case where the PDUs (i.e., PDCP SDUs) constituting the PDU set arrive at the PDCP layer, a method in which the PDCP entity operates the discardTimer on a per-PDU basis may also be considered. In this case, the PDCP entity may start the discardTimer corresponding to each PDU (i.e., PDCP SDU) constituting a specific PDU set when the corresponding PDU arrives at the PDCP layer. Thereafter, when the discardTimer corresponding to any PDU (i.e., PDCP SDU) constituting a specific PDU set expires, the PDCP entity may discard all other PDUs (i.e., PDCP SDUs) constituting the corresponding PDU set. However, in this embodiment, PDCP discarding is performed on a per-PDU set basis, which may result in inefficiency as individual timers are unnecessarily operated on a per-PDU basis.

In addition, in relation to the network indication-based PDU or PDU set discarding operation described through the embodiments of FIGS. 4, 5, 6, 8, 9, and 10, new UE capability information variables as follows may be newly defined within an RRC UECapability Information message.
Indicator of whether to support a PDU set discarding: A new indicator may be introduced to indicate whether the UE supports the PDU set discarding operation described in FIG. 10. The UE may report to the base station that the UE may perform the PDU set discarding operation through the corresponding indicator. The base station may configure the UE to perform the PDU set discarding operation based on the indicator.
Indicator of whether to support a PSI-based PDU/PDU set discarding: As in the embodiments of FIGS. 4, 5, and 6, a new indicator may be introduced to indicate whether the UE may perform a PDU set importance (PSI)-based PDU/PDU set discarding operation according to a network indication. The UE may report to the base station that the UE may perform the PSI-based PDU/PDU set discarding operation through the corresponding indicator. Based on the indicator, the base station may configure the UE to perform the PDU set discarding operation as in the embodiments of FIGS. 4, 5, and 6. For reference, to indicate whether the UE supports the PSI-based PDU/PDU set discarding operation, a new indicator may not be separately defined and the indicator of whether to support the PDU set discarding may be reused. In this case, whether or not the PDU set discarding operation may be supported and whether the PSI-based PDU/PDU set discarding operation may be supported may be simultaneously indicated through the indicator of whether to the PDU set discarding.
Indicator of whether to support a discard timer operation for each PSI: As shown in FIG. 7 above, a new indicator may be introduced to indicate whether the UE may perform the discard timer operation for each PSI. The UE may report to the base station that the UE may operate a separate discard timer for each PSI through the corresponding indicator. Based on the indicator, the base station may configure the UE to operate a separate discard timer for each PSI as in the embodiment of FIG. 7. For reference, in order to indicate whether the UE supports the discard timer operation for each PSI, the indicator of whether to support the PDU set discarding may be reused without a new indicator being separately defined. In this case, whether the PDU set discarding operation is supported and whether the discard timer operation for each PSI is supported may be indicated through the indicator of whether to support the PDU set discarding.
Indicator of whether to support a discard timer change operation on a per-DRB basis: As shown in FIG. 8 above, a new indicator may be introduced to indicate whether the UE may perform an operation to change the discard timer value to be used in a specific DRB according to a network indication. Through the corresponding indicator, the UE may report to the base station that the UE may perform an operation to change the discard timer value to be used in a specific DRB according to a network indication. Based on the indicator, the base station may configure a plurality of discard timer values for each DRB of the UE as in the embodiment of FIG. 8 and then indicate the UE to use a specific discard timer value according to a network situation.
Indicator of whether to support a PSI-based UE assistance information reporting operation: As shown in FIG. 9, a new indicator may be introduced to indicate whether the UE may perform the PSI-based UE assistance information reporting operation according to a network indication. The UE may report to the base station that the UE may perform the PSI-based UE assistance information reporting operation through the corresponding indicator. Based on the indicator, the base station may indicate the UE to report the PSI-based UE assistance information as in the embodiment of FIG. 9. For reference, to indicate whether the UE supports the PSI-based UE assistance information reporting operation, a new indicator may not be separately defined and the indicator of whether to support the PDU set discarding may be reused. In this case, whether the PDU set discarding operation is supported and whether the PSI-based UE assistance information reporting operation is supported may be indicated through the indicator of whether to support the PDU set discarding.

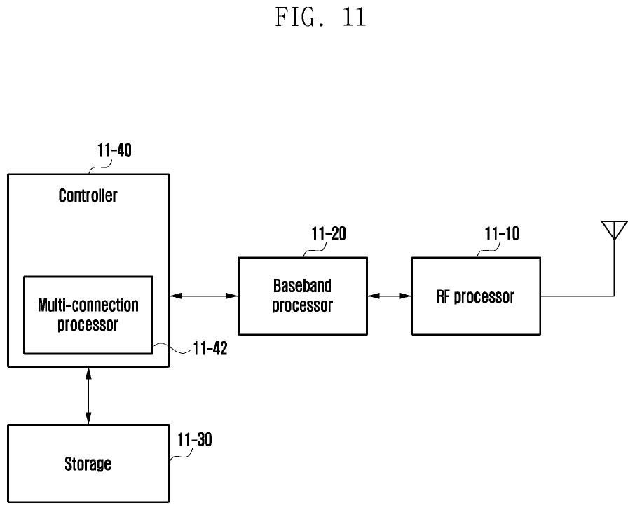

FIG. 11 is a block diagram illustrating an internal structure of a UE according to an embodiment of the disclosure.

With reference to FIG. 11, the UE includes a radio frequency (RF) processor 11-10, a baseband processor 11-20, a storage 11-30, and a controller 11-40. Also, the UE is not limited thereto and may include a smaller or larger number of components compared to the components illustrated in FIG. 11. The RF processor 11-10 may perform functions for transmitting and receiving signals through radio channels, e.g., band conversion and amplification of signals. That is, the RF processor 11-10 may up-convert a baseband signal provided from the baseband processor 11-20, into a RF band signal and then transmit the RF band signal through an antenna, and down-convert an RF band signal received through an antenna, into a baseband signal. For example, the RF processor 11-10 may include a transmitting filter, a receiving filter, an amplifier, a mixer, an oscillator, a digital-to-analog convertor (DAC), an analog-to-digital convertor (ADC), and the like. Although only one antenna is illustrated in FIG. 11, the UE may include a plurality of antennas. Also, the RF processor 11-10 may include a plurality of RF chains. Further, the RF processor 11-10 may perform beamforming. For beamforming, the RF processor 11-10 may adjust each of the phases and sizes of signals to be transmitted or having received through a plurality of antennas or antenna elements. Also, the RF processor 11-10 may perform MIMO and may receive data of a plurality of layers in the MIMO operation. The RF processor 11-10 may perform received beam sweeping by appropriately configuring a plurality of antennas or antenna elements, or adjust a beam direction and beam width of a received beam to coordinate with a transmit beam, under the control of the controller 11-40.

The baseband processor 11-20 may convert between a baseband signal and a bitstream based on PHY layer specifications of a system. For example, for data transmission, the baseband processor 11-20 may generate complex symbols by encoding and modulating a transmit bitstream. Also, for data reception, the baseband processor 11-20 may reconstruct a received bitstream by demodulating and decoding a baseband signal provided from the RF processor 11-10. For example, according to an orthogonal frequency division multiplexing (OFDM) scheme, for data transmission, the baseband processor 11-20 may generate complex symbols by encoding and modulating a transmit bitstream, map the complex symbols to subcarriers, and then constitute OFDM symbols by performing inverse fast Fourier transformation (IFFT) and cyclic prefix (CP) insertion. Also, for data reception, the baseband processor 11-20 may segment a baseband signal provided from the RF processor 11-10, into OFDM symbol units, reconstruct signals mapped to subcarriers by performing fast Fourier transformation (FFT) operation, and then reconstruct a received bitstream by demodulating and decoding the signals.

The baseband processor 11-20 and the RF processor 11-10 may transmit and receive signals as described above. The baseband processor 11-20 and the RF processor 11-10 may also be called a transmitter, a receiver, a transceiver, or a communicator. Further, at least one of the baseband processor 11-20 and the RF processor 11-10 may include a plurality of communication modules to support a plurality of different radio access technologies. Also, at least one of the baseband processor 11-20 and the RF processor 11-10 may include different communication modules to process signals of different frequency bands. For example, the different radio access technologies may include wireless LAN (e.g., IEEE 802.11), cellular network (e.g., LTE), etc. Also, the different frequency bands may include a super-high frequency (SHF) (e.g., 2.NRHz, NRhz) band and a millimeter wave (mmWave) (e.g., 60 GHz) band. The UE may transmit and receive signals to and from a base station by using the baseband processor 11-20 and the RF processor 11-10, and the signals may include control information and data.

The storage 11-30 may store basic programs, application programs, and data, e.g., configuration information, for operations of the UE. In particular, the storage 11-30 may store information related to a second access node that performs wireless communication using a second wireless access technology. Also, the storage 11-30 may provide the stored data upon request by the controller 11-40. Also, the storage 11-30 may include a plurality of memories. According to an embodiment, the storage 11-30 may store a program for performing the split bearer operation method of the disclosure.

The controller 11-40 may control overall operations of the UE. For example, the controller 11-40 may transmit and receive signals through the baseband processor 11-20 and the RF processor 11-10. Also, the controller 11-40 may record and read data on or from the storage 11-30. To do this, the controller 11-40 may include at least one processor. For example, the controller 11-40 may include a communication processor (CP) for controlling communications and an application processor (AP) for controlling an upper layer such as an application program. Also, at least one component within the UE may be implemented with one chip. Also, according to an embodiment of the disclosure, the controller 11-40 may include a multi-connection processor 11-42 to perform processing for an operation in a multi-connection mode.

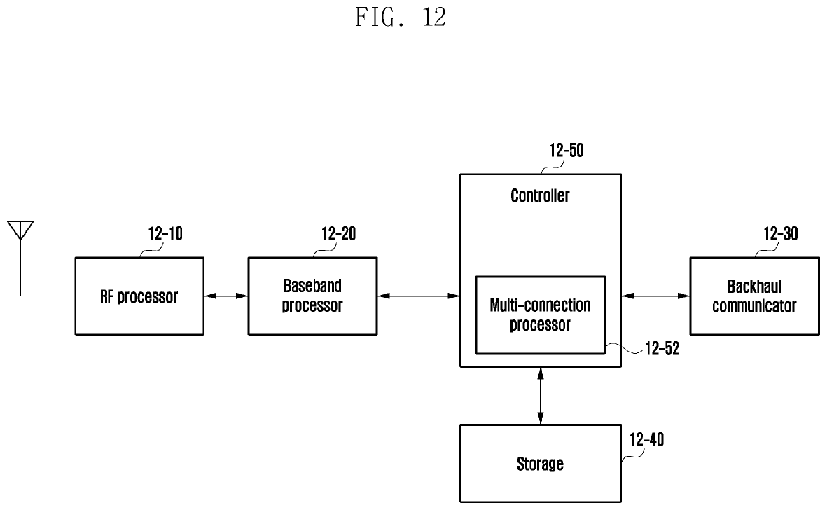

FIG. 12 is a block diagram illustrating a structure of a base station according to an embodiment of the disclosure.

With reference to FIG. 12, a base station may include a RF processor 12-10, a baseband processor 12-20, a backhaul communicator 12-30, a storage 12-40, and a controller 12-50, the base station is not limited thereto and may include a smaller or larger number of components compared to the components illustrated in FIG. 12.

The RF processor 12-10 may perform functions for transmitting and receiving signals through radio channels, e.g., band conversion and amplification of signals. The RF processor 12-10 may up-convert a baseband signal provided from the baseband processor 12-20, into a RF band signal and then transmit the RF band signal through an antenna, and down-convert an RF band signal received through an antenna, into a baseband signal. For example, the RF processor 12-10 may include a transmitting filter, a receiving filter, an amplifier, a mixer, an oscillator, a DAC, and an ADC. Although only one antenna is illustrated in FIG. 12, the base station may include a plurality of antennas. Also, the RF processor 12-10 may include a plurality of RF chains. Further, the RF processor 12-10 may perform beamforming. For beamforming, the RF processor 12-10 may adjust phases and sizes of signals to be transmitted or having received through a plurality of antennas or antenna elements. The RF processor 12-10 may perform down MIMO operation by transmitting data of one or more layers. The RF processor 12-10 may perform received beam sweeping by appropriately configuring a plurality of antennas or antenna elements, or adjust a beam direction and beam width of a received beam to coordinate with a transmit beam, under the control of the controller.

The baseband processor 12-20 may convert between a baseband signal and a bitstream based on PHY layer specifications of a first wireless access technology. For example, for data transmission, the baseband processor 12-20 may generate complex symbols by encoding and modulating a transmit bitstream. Also, for data reception, the baseband processor 12-20 may reconstruct a received bitstream by demodulating and decoding a baseband signal provided from the RF processor 12-10. For example, according to an OFDM scheme, for data transmission, the baseband processor 12-20 may generate complex symbols by encoding and modulating a transmit bitstream, map the complex symbols to subcarriers, and then constitute OFDM symbols by performing IFFT operation and CP insertion. Also, for data reception, the baseband processor 12-20 may segment a baseband signal provided from the RF processor 12-10, into OFDM symbol units, reconstruct signals mapped to subcarriers by performing FFT operation, and then reconstruct a received bitstream by demodulating and decoding the signals. The baseband processor 12-20 and the RF processor 12-10 may transmit and receive signals as described above. Accordingly, the baseband processor 12-20 and the RF processor 12-10 may also be called a transmitter, a receiver, a transceiver, a communicator, or a wireless communicator. The base station may transmit and receive signals to and from the UE by using the baseband processor 12-20 and the RF processor 12-10, and the signals may include control information and data.

The backhaul communicator 12-30 may provide an interface for communicating with other nodes in a network. That is, the backhaul communicator 12-30 may convert a bitstream transmitted from a main base station to another node, for example, an auxiliary base station, a core network, or the like, into a physical signal and may convert a physical signal received from another node into a bitstream.

The storage 12-40 may store basic programs, application programs, and data, e.g., configuration information, for operations of the base station. In particular, the storage 12-40 may store information about bearers allocated for a connected UE, measurement results reported from the connected UE, and the like. Also, the storage 12-40 may store criteria information used to determine whether to provide or release multi-connectivity to or from the UE. Also, the storage 12-40 may provide the stored data upon request by the controller 12-50. The storage 12-40 may store a program for performing the split bearer operation method of the disclosure.

The controller 12-50 may control overall operations of the base station. For example, the controller 12-50 may transmit and receive signals through the baseband processor 12-20 and the RF processor 12-10, or the backhaul communicator 12-30. Also, the controller 12-50 may record and read data on or from the storage 12-40. To do this, the controller 12-50 may include at least one processor. Also, at least one component of the base station may be implemented with one chip. Also, each component of the base station may be operated in order to the embodiments of the above described embodiments of the disclosure.

The methods according to the embodiments of the disclosure as described herein or in the claims may be implemented as hardware, software, or a combination of hardware and software.

In case of being implemented as software, a computer-readable storage medium storing one or more programs (e.g., software modules) may be provided. The one or more programs stored in the computer-readable storage medium are configured for execution by one or more processors in an electronic device. The one or more programs include instructions directing the electronic device to execute the methods according to the embodiments of the disclosure as described herein or in the claims.

The programs (e.g., software modules or software) may be stored in non-volatile memory including random access memory (RAM) or flash memory, read only memory (ROM), electrically erasable programmable read only memory (EEPROM), a magnetic disc storage device, a compact Disc-ROM (CD-ROM), a Digital Versatile Discs (DVDs), another optical storage device, or a magnetic cassette. Alternatively, the programs may be stored in memory including a combination of some or all of the above-mentioned storage media. Also, a plurality of such memories may be included.

In addition, the programs may be stored in an attachable storage device accessible through any or a combination of communication networks such as the Internet, an intranet, a local area network (LAN), a wide LAN (WLAN), and a storage area network (SAN). Such a storage device may access the apparatus performing the embodiments of the disclosure via an external port. Furthermore, an additional storage device on the communication network may access the apparatus performing the embodiments of the disclosure.

In the above particular embodiments of the disclosure, the components included in the disclosure are expressed in the singular or plural according to the presented particular embodiments of the disclosure. However, the singular or plural expressions are selected suitably according to the presented situations for convenience of description, the disclosure is not limited to the singular or plural components, and the components expressed in the plural may even be configured in the singular or the components expressed in the singular may even be configured in the plural.

While the detailed description of the disclosure has been shown and described with reference to various embodiments thereof, it is apparent that various changes in form and details may be made therein without departing from the scope of the disclosure. Therefore, the scope of the disclosure should not be limited to the described embodiments, but should be determined not only by the scope of the claims described later, but also by the scope of claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a communication system, the method comprising:
receiving, from a base station, a radio resource control (RRC) message including a first value of a first timer and a second value of a second timer for low importance;
receiving, from the base station, a medium access control (MAC) control element (CE) for activating a protocol data unit (PDU) set importance (PSI) based discard;
starting the second timer based on reception of a packet data convergence protocol (PDCP) service data unit (SDU) belonging to a low importance PDU set; and
discarding the PDCP SDU belonging to the low importance PDU set based on an expiration of the second timer.

2. The method of claim 1, further comprising:
starting the first timer based on reception of a PDCP SDU that does not belong to the low importance PDU set; and
discarding the PDCP SDU that does not belong to the low importance PDU set based on an expiration of the first timer.

3. The method of claim 1, further comprising:
transmitting, to the base station, a capability message including information indicating that the terminal supports a PDU set based discard and information indicating that the terminal supports the PSI based discard.

4. The method of claim 1, wherein the MAC CE includes a data radio bearer (DRB) identity (ID) configured with the PSI based discard, and
wherein the second value of the second timer is set to one of a plurality of values including 0.

5. A method performed by a base station in a communication system, the method comprising:
transmitting, to a terminal, a radio resource control (RRC) message including a first value of a first timer and a second value of a second timer; and
transmitting, to the terminal, a medium access control (MAC) control element (CE) for activating a protocol data unit (PDU) set importance (PSI) based discard,
wherein the second timer is associated with a packet data convergence protocol (PDCP) service data unit (SDU) belonging to a low importance PDU set, and
wherein the PDCP SDU belonging to the low importance PDU set is discarded based on an expiration of the second timer.

6. The method of claim 5, wherein the first timer is associated with a PDCP SDU that does not belong to the low importance PDU set, and
wherein the PDCP SDU that does not belong to the low importance PDU set is discarded based on an expiration of the first timer.

7. The method of claim 5, further comprising:
receiving, from the terminal, a capability message including information indicating that the terminal supports a PDU set based discard and information indicating that the terminal supports the PSI based discard.

8. The method of claim 5, wherein the MAC CE includes a data radio bearer (DRB) identity (ID) configured with the PSI based discard, and
wherein the second value of the second timer is set to one of a plurality of values including 0.

9. A terminal in a communication system, the terminal comprising:
a transceiver; and
a controller configured to:
receive, from a base station, via the transceiver, a radio resource control (RRC) message including a first value of a first timer and a second value of a second timer for low importance, and
receive, from the base station, via the transceiver, a medium access control (MAC) control element (CE) for activating a protocol data unit (PDU) set importance (PSI) based discard,
start the second timer based on reception of a packet data convergence protocol (PDCP) service data unit (SDU) belonging to a low importance PDU set, and
discard the PDCP SDU belonging to the low importance PDU set based on an expiration of the second timer.

10. The terminal of claim 9, wherein the controller is further configured to:
start the first timer based on reception of a PDCP SDU that does not belong to the low importance PDU set, and
discard the PDCP SDU that does not belong to the low importance PDU set based on an expiration of the first timer.

11. The terminal of claim 9, wherein the controller is further configured to transmit, to the base station, via the transceiver, a capability message including information indicating that the terminal supports a PDU set based discard and information indicating that the terminal supports the PSI based discard.

12. The terminal of claim 9, wherein the MAC CE includes a data radio bearer (DRB) identity (ID) configured with the PSI based discard, and
wherein the second value of the second timer is set to one of a plurality of values including 0.

13. A base station in a communication system, the base station comprising:
a transceiver; and
a controller configured to:
transmit, to a terminal, via the transceiver, a radio resource control (RRC) message including a first value of a first timer and a second value of a second timer, and
transmit, to the terminal, via the transceiver, a medium access control (MAC) control element (CE) for activating a protocol data unit (PDU) set importance (PSI) based discard,
wherein the second timer is associated with a packet data convergence protocol (PDCP) service data unit (SDU) belonging to a low importance PDU set, and
wherein the PDCP SDU belonging to the low importance PDU set is discarded based on an expiration of the second timer.

14. The base station of claim 13, wherein the first timer is associated with a PDCP SDU that does not belong to the low importance PDU set, and
wherein the PDCP SDU that does not belong to the low importance PDU set is discarded based on an expiration of the first timer.

15. The base station of claim 13, wherein the controller is further configured to receive, from the terminal, via the transceiver, a capability message including information indicating that the terminal supports a PDU set based discard and information indicating that the terminal supports the PSI based discard.

16. The base station of claim 13, wherein the MAC CE includes a data radio bearer (DRB) identity (ID) configured with the PSI based discard, and
wherein the second value of the second timer is set to one of a plurality of values including 0.
